(19) United States
(12) Patent Application Publication
(10) Pub. No.: US 2026/0113543 A1
(43) Pub. Date: Apr. 23, 2026

(54) SYSTEMS AND METHODS FOR IMAGE ADJUSTMENT

(71) Applicant: ZHEJIANG DAHUA TECHNOLOGY CO., LTD., Hangzhou (CN)

(72) Inventors: Jianmiao WANG, Hangzhou (CN); Feiyue ZHU, Hangzhou (CN); Xuemin TANG, Hangzhou (CN)

(73) Assignee: ZHEJIANG DAHUA TECHNOLOGY CO., LTD., Hangzhou (CN)

(21) Appl. No.: 19/424,081

(22) Filed: Dec. 17, 2025

Related U.S. Application Data
(63) Continuation of application No. PCT/CN2024/110449, filed on Aug. 7, 2024.

(30) Foreign Application Priority Data
Aug. 31, 2023 (CN) 202311122624.6

(51) Int. Cl. H04N 23/72; H04N 23/73; H04N 23/76; H04N 23/88

(52) U.S. Cl. CPC H04N 23/72; H04N 23/73; H04N 23/76; H04N 23/88

(57) ABSTRACT

The present disclosure provides a system and method for image adjustment. The method may include determining information of a black block based on pixel parameters of image blocks in a captured frame of a camera, the image blocks being determined based on pre-dividing the captured frame; determining a state of the camera based on the information of the black block, the state being one of a normal operation state, a partial masking state, or a full-masking state; and adjusting a shooting parameter of the camera based on the state of the camera.

### CROSS-REFERENCE TO RELATED APPLICATIONS

This application is a continuation of International Patent Application No. PCT/CN2024/110449, filed on Aug. 7, 2024, which claims priority of Chinese Patent Application No. 202311122624.6, filed on Aug. 31, 2023, the contents of each of which are hereby incorporated by reference in its entirety.

### TECHNICAL FIELD

The disclosure generally relates to the field of camera image technology, and more particularly, relates to systems and methods for image adjustment.

### BACKGROUND

With the development of science and technology, more and more household, civilian, and commercial devices are equipped with cameras. As a rapidly developing emerging force, smart screens can be used as whiteboards or chalkboards for writing during classes or meetings, as well as for remote video conferences. Although smart screens bring a lot of convenience to people, there is also a risk of privacy leakage because of the presence of cameras. Even when the camera is not turned on or powered off, consumers may have certain doubts about whether the camera is still working. Therefore, it is desired to provide a privacy protection solution so that consumers can have confidence in the privacy protection of the camera.

### SUMMARY

According to a first aspect of the present disclosure, a method for image adjustment is provided. The method may be implemented on at least one computing device, each of which may include at least one processor and a storage device. The method may include determining information of a black block based on pixel parameters of image blocks in a captured frame of a camera, the image blocks being determined based on pre-dividing the captured frame; determining a state of the camera based on the information of the black block, the state being one of a normal operation state, a partial masking state, or a full-masking state; and adjusting a shooting parameter of the camera based on the state of the camera.

In some embodiments, the information of the black block comprises at least one of a location, an area, or a distribution region of the black block.

In some embodiments, the determining a state of the camera based on the information of the black block includes: determining the state to be the full-masking state in response to an area of the black block and an area of the captured frame satisfying a first area condition.

In some embodiments, the determining the state to be the full-masking state in response to an area of the black block and an area of the captured frame satisfying a first area condition includes: in response to the area of the black block and the area of the captured frame satisfying the first area condition, and a current shutter parameter and a current gain parameter of the camera satisfying a preset parameter condition, determining the state to be an initial full-masking state; and in response to a duration of the initial full-masking state being greater than or equal to a preset time, determining the state to be the full-masking state.

In some embodiments, the determining a state of the camera based on the information of the black block includes: determining the state to be the partial masking state in response to an area of the black block and an area of the captured frame satisfying a second area condition.

In some embodiments, the determining the state to be the partial masking state in response to an area of the black block and an area of the captured frame satisfying a second area condition includes: in response to the area of the black block and the area of the captured frame satisfying the second area condition, determining whether a distribution region of the black block includes at least one black block row or at least one black block column; and in response to the distribution region of the black block comprising the at least one black block row or at least one black block column, and a short side of the at least one black block row or at least one black block column being greater than or equal to a preset width, determining the state to be the partial masking state; wherein a long side of the at least one black block row or at least one black block column coincides with and is equal in length to a side of the captured frame.

In some embodiments, the determining a state of the camera based on the information of the black block includes: determining the state to be the normal operation state in response to an area of the black block satisfying a third area condition.

In some embodiments, the determining the state to be the normal operation state in response to an area of the black block satisfying a third area condition includes: in response to the area of the black block satisfying the third area condition and a distribution region of the black block satisfying a preset distribution condition, determining the state to be the normal operation state, wherein the preset distribution condition includes one of the following: no black block row or black block column exists in the distribution region of the black block; or the distribution region of the black block includes the black block row or the black block column, and a short side of any one of the black block row or the black block column is smaller than a preset width.

In some embodiments, the adjusting a shooting parameter of the camera based on the state includes: in response to the state being the full-masking state, determining whether the pixel parameters of the image blocks are greater than a preset value, wherein the pixel parameters include a luminance parameter and a chroma parameter; and in response to the pixel parameters being greater than the preset value, adjusting the shooting parameter until the pixel parameter are less than or equal to the preset value.

In some embodiments, the adjusting a shooting parameter of the camera based on the state includes: in response to the state being the partial masking state, determining a first luminance average of the captured frame based on a luminance parameter of the black block and a luminance parameter of non-black block of the captured frame; determining a first chroma sum value based on a chroma parameter of the non-black block; and adjusting the captured frame based on the first luminance average and the first chroma sum value.

In some embodiments, the adjusting the captured frame based on the first luminance average and the first chroma sum value includes: determining a second luminance average and a second chroma sum value for a non-boundary region of the captured frame; and adjusting the captured frame based on the first luminance average, the first chroma sum value, the second luminance average, and the second chroma sum value.

In some embodiments, the determining a first luminance average of the captured frame based on a luminance parameter of the black block and a luminance parameter of non-black block of the captured frame includes: determining the first luminance average based on the luminance parameter of the black block, the luminance parameter of non-black block, a first weight coefficient corresponding to the black block and a second weight coefficient corresponding to the non-black block, the second weight coefficient being larger than the first weight coefficient.

In some embodiments, the first weight coefficient and the second weight coefficient correlate to a distribution characteristic of the black block and an environmental characteristic of the captured frame.

In some embodiments, the luminance parameter of non-black block is determined based on a weighted summation, and the weighted summation is determined based on the luminance parameter of a plurality of sub-regions of a non-blocked region, and the plurality of sub-regions are determined based on grouping image blocks of the non-blocked region.

In some embodiments, the method further includes: in response to the state being the partial masking state, determining a location information of the non-black block in the captured frame; and controlling the camera to refocus based on the location information of the non-black block.

In some embodiments, the controlling the camera to refocus based on the location information of the non-black block includes: determining a non-boundary region or a region of interest in a non-blocked region based on the location information of the non-black block; and controlling the camera to refocus based on the non-boundary region or the region of interest.

In some embodiments, the adjusting a shooting parameter of the camera based on the state includes: determining a target shooting parameter based on the pixel parameters of the image blocks, target pixel parameters of the image blocks, and a current shooting parameter of the camera.

In some embodiments, the adjusting a shooting parameter of the camera based on the state includes: in response to the state being the normal operation state, and before the normal operation state, the state being the full-masking state or the partial masking state, restoring the shooting parameter to a default value.

According to a second aspect of the present disclosure, a system for image adjustment is provided. The system may include a state judgment module and an image adjustment module. The state judgment module may be configured to determine information of a black block based on pixel parameters of image blocks in a captured frame of a camera, the image blocks being determined based on pre-dividing the captured frame; and determine a state of the camera based on the information of the black block, the state being one of a normal operation state, a partial masking state, and a full-masking state. The image adjustment module may be configured to adjust a shooting parameter of the camera based on the state.

According to a third aspect of the present disclosure, a device for image adjustment is provided. The device may include at least one processor and at least one storage device. The at least one storage device is configured to store executable instructions for image adjustment. The at least one processor is in communication with the at least one storage device, wherein when executing the executable instructions, the at least one processor is configured to cause the device to perform operations including: determining information of a black block based on pixel parameters of image blocks in a captured frame of a camera, the image blocks being determined based on pre-dividing the captured frame; determining a state of the camera based on the information of the black block, the state being one of a normal operation state, a partial masking state, or a full-masking state; and adjusting a shooting parameter of the camera based on the state.

According to a forth aspect of the present disclosure, a non-transitory computer readable medium storing at least one set of instructions is provided. When executed by a computer, the set of instructions direct the computer to perform a method. The method may include determining information of a black block based on pixel parameters of image blocks in a captured frame of a camera, the image blocks being determined based on pre-dividing the captured frame; determining a state of the camera based on the information of the black block, the state being one of a normal operation state, a partial masking state, or a full-masking state; and adjusting a shooting parameter of the camera based on the state.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. The drawings are not to scale. These embodiments are non-limiting exemplary embodiments, in which like reference numerals represent similar structures throughout the several views of the drawings, and wherein:

FIG. 1 is a schematic diagram illustrating an exemplary image adjustment system according to some embodiments of the present disclosure;

FIG. 2 is a schematic diagram illustrating exemplary hardware and/or software components of an exemplary computing device according to some embodiments of the present disclosure;

FIG. 3 is schematic diagram illustrating that a camera of a smart screen is blocked by a physical structure according to some embodiments of the present disclosure;

FIG. 4 is a block diagram illustrating an exemplary processing device according to some embodiments of the present disclosure;

FIG. 5A is a flowchart illustrating an exemplary process for image adjustment according to some embodiments of the present disclosure;

FIG. 5B is a flowchart illustrating an exemplary process for image adjustment according to some embodiments of the present disclosure;

FIG. 6 is a schematic diagram illustrating an exemplary manner for dividing a captured frame into a plurality of image blocks according to some embodiments of the present disclosure;

FIG. 7 is a flowchart illustrating an exemplary process for determining a state of a camera according to some embodiments of the present disclosure;

FIG. 8A is a schematic diagram illustrating exemplary frames captured by a camera when the camera is in a partial masking state according to some embodiments of the present disclosure;

FIG. 8B is a schematic diagram illustrating an exemplary frame captured by a camera when the camera is in a normal operation state according to some embodiments of the present disclosure;

FIG. 8C is a schematic diagram illustrating an exemplary frame captured by a camera when the camera is in a full-masking state according to some embodiments of the present disclosure;

FIG. 9 is a flowchart illustrating an exemplary process for image adjustment according to some embodiments of the present disclosure;

FIG. 10 is a flowchart illustrating an exemplary process for image adjustment according to some embodiments of the present disclosure; and

FIG. 11 is a schematic diagram illustrating exemplary captured frames adjusted before and after by the image adjustment method provided in some embodiments of the present disclosure.

### DETAILED DESCRIPTION

The following description is presented to enable any person skilled in the art to make and use the present disclosure and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including” when used in this disclosure, specify the presence of stated features, integers, steps, operations, elements, and/or components, but do not preclude the presence or addition of one or more other features, integers, steps, operations, elements, components, and/or groups thereof.

It will be understood that the term “system,” “engine,” “unit,” “module,” and/or “block” used herein are one method to distinguish different components, elements, parts, sections or assembly of different levels in ascending order. However, the terms may be displaced by another expression if they achieve the same purpose.

It will be understood that, although the terms “first,” “second,” “third,” etc., may be used herein to describe various elements, these elements should not be limited by these terms. These terms are only used to distinguish one element from another. For example, a first element could be termed a second element, and, similarly, a second element could be termed a first element, without departing from the scope of exemplary embodiments of the present disclosure.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments in the present disclosure. It is to be expressly understood, the operations of the flowchart may be implemented not in order. Conversely, the operations may be implemented in an inverted order, or simultaneously. Moreover, one or more other operations may be added to the flowcharts. One or more operations may be removed from the flowcharts.

Provided herein are systems and methods for image adjustment. The systems and methods can be applied to electronic devices with cameras installed, such as image monitoring devices, smart screens, computers, smartphones, tablets, etc. The systems and methods may determine information of a black block based on pixel parameters of image blocks in a captured frame of a camera. The image blocks may be determined based on pre-dividing the captured frame. The systems and methods may further determine a state of the camera based on the information of the black block. The state may be one of a normal operation state, a partial masking state, or a full-masking state. The systems and methods may adjust a shooting parameter of the camera based on the state of the camera.

In some embodiments, a pixel parameter of an image block at least includes a luminance value of the image block. By determining an image block with a luminance value less than a preset luminance threshold as a black block, and by determining a total area and the distribution of the black blocks in the captured frame, the current masking state of the camera can be accurately determined. Accordingly, based on a current masking state of the camera, the camera's shooting parameter can be adjusted to adaptively adjust the captured frame, thereby improving the image quality of the captured frame.

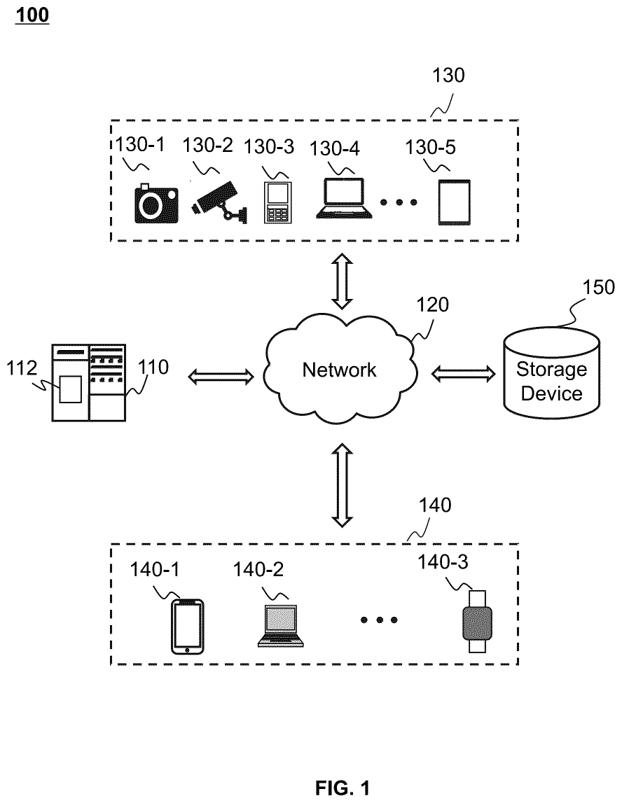

FIG. 1 is a schematic diagram illustrating an exemplary image adjustment system according to some embodiments of the present disclosure. As shown in FIG. 1, the image adjustment system 100 may include a server 110, a network 120, an image acquisition device 130, a terminal device 140, and a storage device 150.

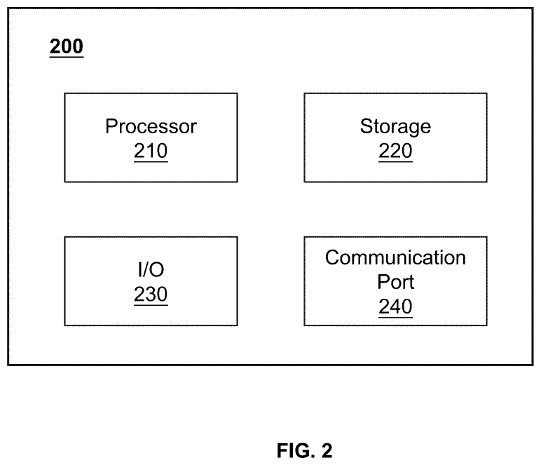

The server 110 may be a single server or a server group. The server group may be centralized or distributed (e.g., the server 110 may be a distributed system). In some embodiments, the server 110 may be local or remote. In some embodiments, the server 110 may be implemented on a cloud platform. In some embodiments, the server 110 may be implemented on a computing device 200 having one or more components illustrated in FIG. 2 in the present disclosure.

In some embodiments, the server 110 may include a processing device 112. The processing device 112 may process data and/or information relating to image adjustment to perform one or more functions described in the present disclosure. For example, the processing device 112 may determine information of a black block based on pixel parameters of image blocks in a captured frame of a camera, and determine a state of the camera based on the information of the black block. Further, the processing device 112 may adjust a shooting parameter of the camera based on the state of the camera. In some embodiments, the processing device 112 may include one or more processing engines (e.g., single-core processing engine(s) or multi-core processor(s)).

In some embodiment, the sever 110 may be unnecessary and all or part of the functions of the server 110 may be implemented by other components (e.g., the image acquisition device 130, the terminal device 140) of the image adjustment system 100. For example, the processing device 112 may be integrated into the image acquisition device 130 or the terminal device 140 and the functions of the processing device 112 may be implemented by the image acquisition device 130 (e.g., an image signal processor (ISP) in the image acquisition device 130) or the terminal device 140.

The network 120 may facilitate the exchange of information and/or data for the image adjustment system 100. In some embodiments, one or more components (e.g., the server 110, the image acquisition device 130, the terminal device 140, or the storage device 150) of the image adjustment system 100 may transmit information and/or data to one or more other components of the image adjustment system 100 via the network 120. For example, the server 110 may obtain/acquire images from the image acquisition device 130 via the network 120. As another example, the image acquisition device 130 may transmit images to the storage device 150 for storage via the network 120. In some embodiments, the network 120 may be any type of wired or wireless network, or combination thereof.

The image acquisition device 130 may be configured to acquire at least one image (the “image” herein refers to a single image or a frame of a video). In some embodiments, the image acquisition device 130 may include a camera 130-1, an image monitoring device 130-2, a smartphone 130-3, a computer 130-4, a tablet 130-5, a smart screen (not shown), etc. In some embodiments, the image acquisition device 130 may include a plurality of components each of which can acquire an image. For example, the image acquisition device 130 may include a plurality of sub-cameras that can capture images or videos simultaneously. In some embodiments, the image acquisition device 130 may transmit the acquired image (or captured frame) to one or more components (e.g., the server 110, the terminal device 140, and/or the storage device 150) of the image adjustment system 100 via the network 120.

The terminal device 140 may be configured to receive information and/or data from the server 110, the image acquisition device 130, and/or the storage device 150 via the network 120. For example, the terminal device 140 may receive images and/or videos from the image acquisition device 130. As another example, the terminal device 140 may transmit instructions to the image acquisition device 130 and/or the server 110. In some embodiments, the terminal device 140 may provide a user interface via which a user may view information and/or input data and/or instructions to the image adjustment system 100. For example, the user may view, via the user interface, information associated with a state of a lens of the image acquisition device 130 (also referred to as a state of a camera). As another example, the user may input, via the user interface, an instruction to set a shooting parameter of the image acquisition device 130. In some embodiments, the terminal device 140 may include a mobile device 140-1, a computer 140-2, a wearable device 140-3, or the like, or any combination thereof. In some embodiments, the terminal device 140 may include a display that can display information in a human-readable form, such as text, image, audio, video, graph, animation, or the like, or any combination thereof. In some embodiments, the terminal device 140 may be connected to one or more components (e.g., the server 110, the image acquisition device 130, and/or the storage device 150) of the image adjustment system 100 via the network 120.

The storage device 150 may be configured to store data and/or instructions. The data and/or instructions may be obtained from, for example, the server 110, the image acquisition device 130, and/or any other component of the image adjustment system 100. In some embodiments, the storage device 150 may store data and/or instructions that the server 110 may execute or use to perform exemplary methods described in the present disclosure. In some embodiments, the storage device 150 may include a mass storage device, a removable storage device, a volatile read-and-write memory, a read-only memory (ROM), or the like, or any combination thereof. In some embodiments, the storage device 150 may be implemented on a cloud platform.

FIG. 2 is a schematic diagram illustrating exemplary hardware and/or software components of an exemplary computing device according to some embodiments of the present disclosure. As illustrated in FIG. 2, the computing device 200 may include a processor 210, a storage 220, an input/output (I/O) 230, and a communication port 240.

The processor 210 may execute computer instructions (program code) and perform functions of the processing device 112 in accordance with techniques described herein. The computer instructions may include, for example, routines, programs, objects, components, signals, data structures, procedures, modules, and functions, which perform particular functions described herein. In some embodiments, the processor 210 may perform instructions obtained from the terminal device 140. In some embodiments, the processor 210 may include one or more hardware processors.

Merely for illustration, only one processor is described in the computing device 200. However, it should be noted that the computing device 200 in the present disclosure may also include multiple processors. Thus operations and/or method steps that are performed by one processor as described in the present disclosure may also be jointly or separately performed by the multiple processors. For example, if in the present disclosure the processor of the computing device 200 executes both operation A and operation B, it should be understood that operation A and operation B may also be performed by two or more different processors jointly or separately in the computing device 200 (e.g., a first processor executes operation A and a second processor executes operation B, or the first and second processors jointly execute operations A and B).

The storage 220 may store data/information obtained from the image acquisition device 130, the terminal device 140, the storage device 150, or any other component of the image adjustment system 100. In some embodiments, the storage 220 may include a mass storage device, a removable storage device, a volatile read-and-write memory, a read-only memory (ROM), or the like, or any combination thereof. In some embodiments, the storage 220 may store one or more programs and/or instructions to perform exemplary methods described in the present disclosure. For example, the storage 220 may store a program for the processing device 112 for adjusting a shooting parameter of a camera.

The I/O 230 may input or output signals, data, and/or information. In some embodiments, the I/O 230 may enable user interaction with the processing device 112. In some embodiments, the I/O 230 may include an input device and an output device.

The communication port 240 may be connected with a network (e.g., the network 120) to facilitate data communications. The communication port 240 may establish connections between the processing device 112, the image acquisition device 130, the terminal device 140, or the storage device 150. In some embodiments, the connection may be a wired connection, a wireless connection, or a combination of both that enables data transmission and reception.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

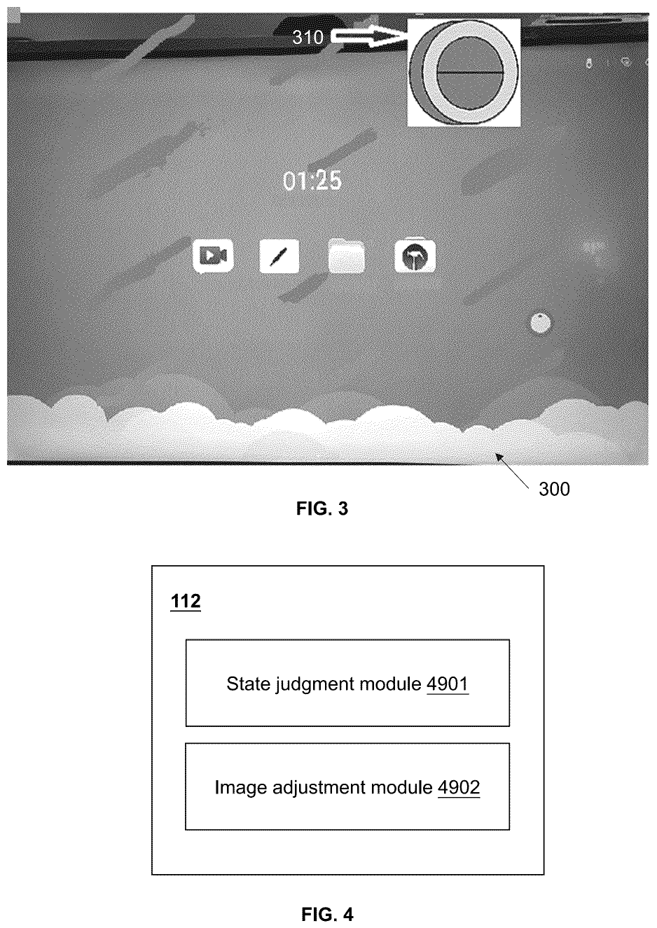

FIG. 3 is schematic diagram illustrating that a camera of a smart screen is blocked by a physical structure according to some embodiments of the present disclosure. As shown in FIG. 3, a camera 310 installed on a smart screen 300 carries a rotating and opening lens privacy cover to protect the user's privacy. The rotating and opening lens privacy cover may be closed by rotating clockwise and opened by rotating counterclockwise. In some embodiments, the rotating and opening lens privacy cover may also be any other physical structure used to block the camera, such as a cover that can slide left to close and slide right to open, etc. When using a physical structure to block the camera to protect consumer privacy, the camera may be in different masking states, such as a normal operation state, a partial masking state, or a full-masking state. As used herein, a normal operation state of a camera refers to a state that the camera (also referred to be the lens of the camera) is not blocked by any object. A partial masking state of a camera refers to a state that at least a part of the camera (also referred to be the lens of the camera) is blocked. A full-masking state of a camera refers to a state that the camera (also referred to be the lens of the camera) is completely blocked.

In the existing technology, the camera cannot determine which masking state it is in, so no matter what masking state the camera is in, it may increase a shutter value and a gain value of the camera when the camera recognizes that the environment becomes dark, which leads problems such as overexposure, noise, and color casts in a frame captured by the camera due to increasing the shutter value and the gain value when the camera is in the partial masking state or the full-masking state.

Generally, in the normal operation state, in order to enable the camera to shoot in a relatively dark environment, an image signal processor (ISP) module may automatically increase the shutter value and gain value of the camera and other shooting parameters to increase the luminance of the captured frame of the camera. Although problems such as noise, white points, black points, and color interference may also be caused, consumers are more concerned about picture luminance under the normal operation state, so it can meet user needs.

In the partial masking state, part of the camera is blocked, and the rest is not blocked. Since the picture corresponding to the blocked part of the camera is black, the ISP module may also automatically increase the camera's shutter value, gain value, and other shooting parameters, which may lead to problems such as overexposure, white balance color cast, etc., in the captured frame of the camera.

In the full-masking state, since the camera is completely blocked, the camera may also recognize that the current environment becomes dark, and the ISP module may also automatically increase the camera's shutter value, gain value, and other shooting parameters, which may also lead to problems such as overexposure, white balance color cast, etc., in the captured frame of the camera. For example, when the camera installed on the smart screen is in the full-masking state, the camera may recognize that the current environment becomes dark and increase the shutter value and the gain value, resulting in problems such as noise, white points, black points, color interference, etc., in the captured frame on the smart screen, thereby affecting user experience. However, at this time, the user usually hopes that the captured frame can be consistent with a picture when the camera is powered off, that is, the smart screen may be a pure black and clean captured frame, and does not want to have problems such as full-screen noise and color interference.

Accordingly, the present disclosure provides an image adjustment method, device, equipment (device), and storage medium, which can automatically identify the state of the camera, thereby making adaptive adjustments to the captured frame of the camera in different masking states and improving the quality of the captured frame.

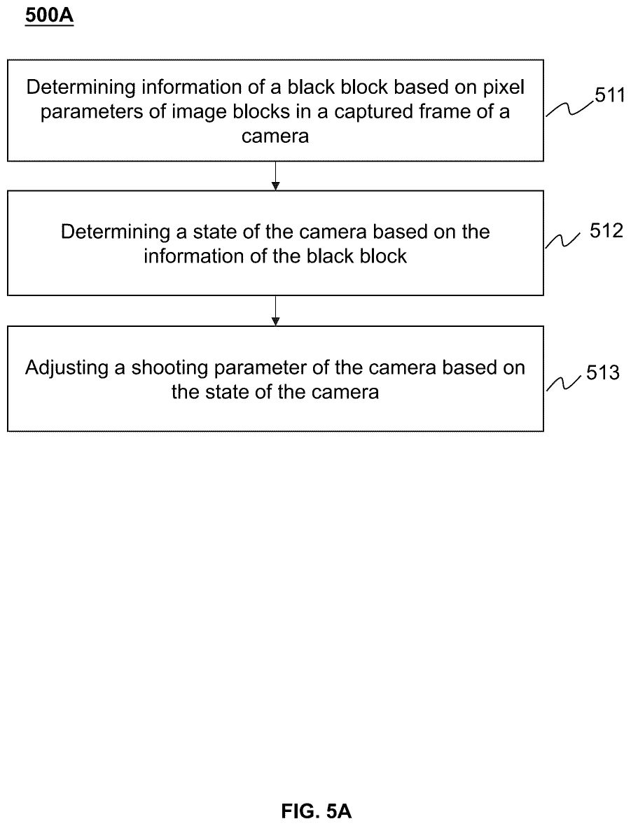

FIG. 4 is a block diagram illustrating an exemplary processing device according to some embodiments of the present disclosure. As illustrated in FIG. 4, the processing device 112 may include a state judgment module 4901 and an image adjustment module 4902.

The state judgment module 4901 may be configured to determine information of a black block based on pixel parameters of image blocks in a captured frame of a camera. The image blocks may be determined based on pre-dividing the captured frame. The state judgment module 4901 may further be configured to determine a state of the camera based on the information of the black block. The state may be one of a normal operation state, a partial masking state, and a full-masking state.

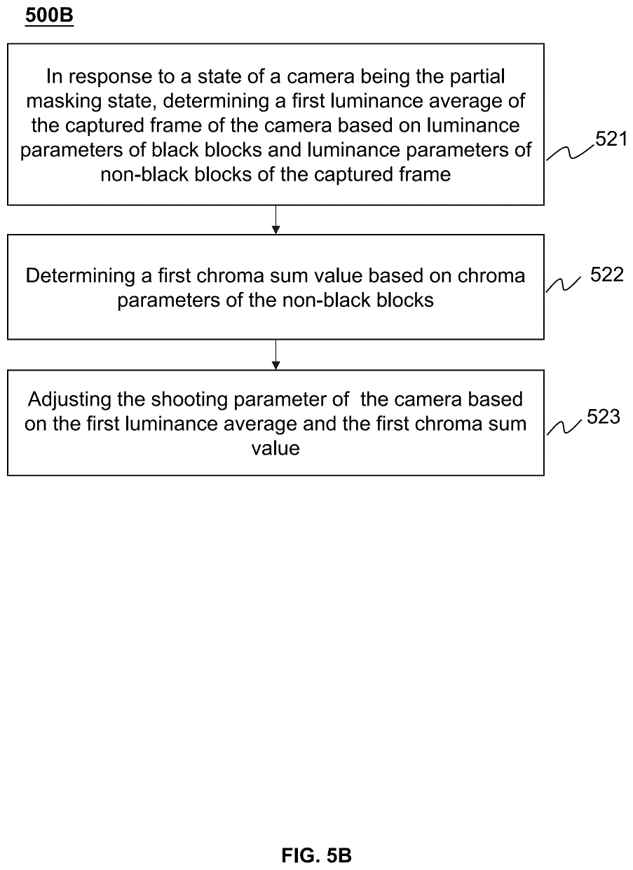

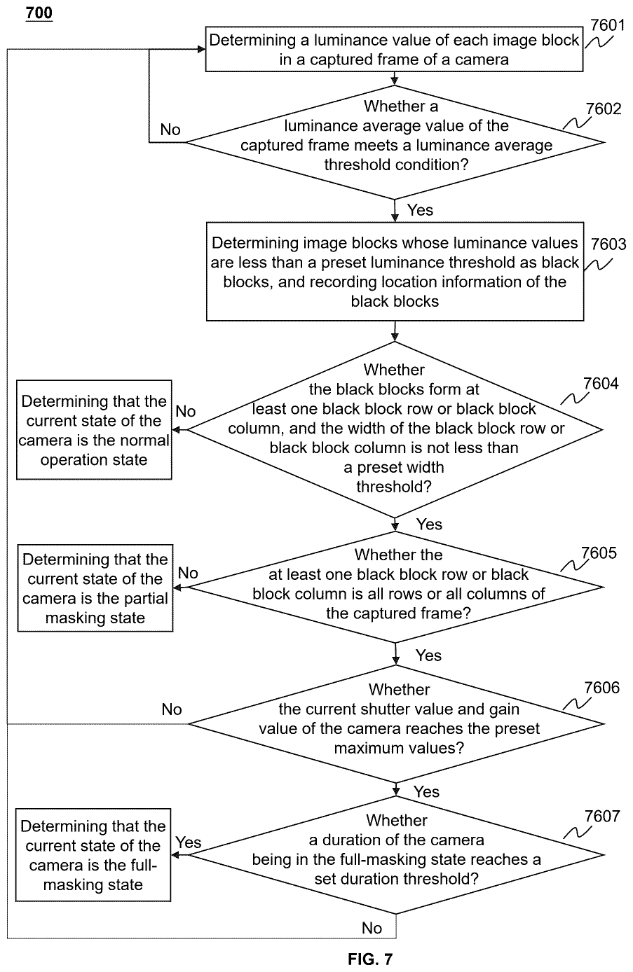

In some embodiments, the pixel parameters may include at least a luminance value of the image block. The state judgment module 4901 may determine image blocks with luminance values less than a preset luminance threshold as black blocks, and determine an area occupied by the black blocks in the captured frame based on location information of the black blocks. The state judgment module 4901 may determine a state of the camera based on the area occupied by the black blocks in the captured frame. More descriptions regarding the determination of the state of the camera may be found elsewhere in the present disclosure, e.g., FIG. 5A and FIG. 7 and the descriptions thereof.

The image adjustment module 4902 may be configured to adjust one or more shooting parameters of the camera based on the state of the camera.

In some embodiments, if the current masking state of the camera is the full-masking state, the image adjustment module 4902 may adjust the shooting parameter(s) of the camera until the luminance values and the chroma values of all image blocks in the captured frame are respectively less than or equal to a preset target luminance value threshold and a preset target chroma value threshold.

In some embodiments, if the current masking state of the camera is the partial masking state, the image adjustment module 4902 may determine a weighted mean value of the luminance values (also referred as a luminance weighted average value) corresponding to the captured frame based on the luminance values of the black blocks in the captured frame, the luminance values of the non-black blocks in the captured frame, a first weight coefficient corresponding to the black blocks, and a second weight coefficient corresponding to the non-black blocks. The second weight coefficient may be greater than the first weight coefficient. The image adjustment module 4902 may further determine a sum of the chroma values (also referred to a chroma sum value) of the captured frame based on the chroma values of the non-black blocks, and adjust the captured frame based on the luminance weighted average value and the chroma sum value.

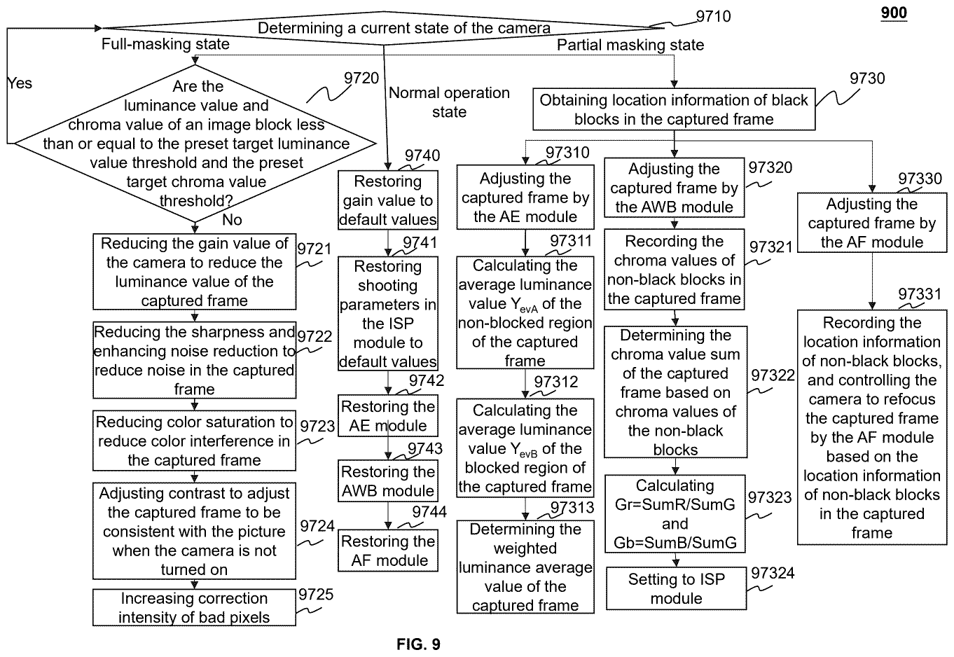

In some embodiments, the image adjustment module 4902 may further be configured to record the location information of the non-black blocks, and control the camera to refocus based on the location information of the non-black blocks in the captured frame. More descriptions regarding the adjustment of the shooting parameter(s) of the camera may be found elsewhere in the present disclosure, e.g., FIG. 5A and FIG. 9 and the descriptions thereof.

The modules in the processing device 112 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. Two or more of the modules may be combined as a single module, and any one of the modules may be divided into two or more units.

FIG. 5A is a flowchart illustrating an exemplary process for image adjustment according to some embodiments of the present disclosure. In some embodiments, process 500A may be implemented as a set of instructions (e.g., an application) stored in a storage device (e.g., the storage device 150, the storage 220), and the processor 210 and/or the modules in FIG. 4 may execute the set of instructions and may accordingly be directed to perform the process 500A.

In 511, the processing device 112 (e.g., the state judgment module 4901) may determine information of a black block based on pixel parameters of image blocks in a captured frame of a camera.

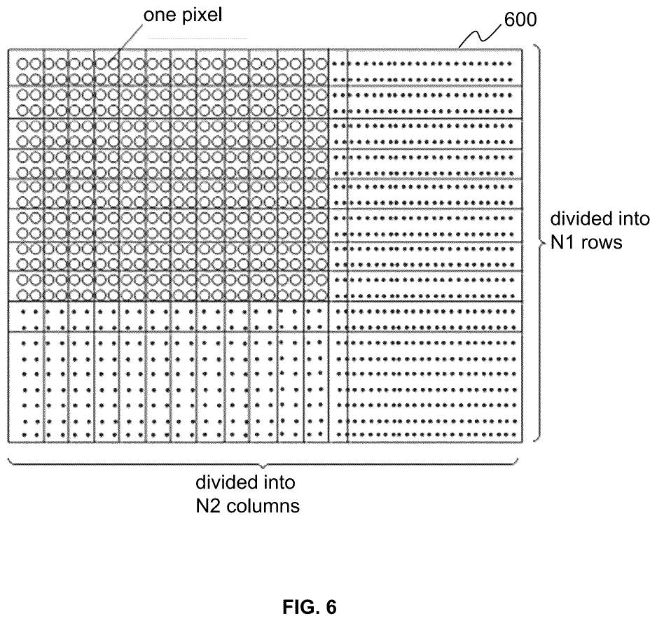

The camera may capture its shooting range in real time to obtain the captured frame. In some embodiments, the processing device 112 may update the captured frame in real time or periodically. The captured frame may be pre-divided to determine the image blocks. Each image block in the captured frame may include one or more pixels. A size of each image block and a count of pixels each image block contains may be the same or different. In some embodiments, the size of each image block may be set according to actual requirements. Exemplary, FIG. 6 is a schematic diagram illustrating an exemplary manner for dividing a captured frame into a plurality of image blocks according to some embodiments of the present disclosure. As shown in FIG. 6, the captured frame 600 is divided into N1 rows and N2 columns, that is, the captured frame is divided into N1×N2 image blocks, wherein N1 and N2 are positive integers greater than or equal to 1. Each image block contains four pixels. In some embodiments, the size of each image block may be determined based on the resolution of the camera. For example, when the performance of the camera is sufficient, the greater the resolution of the camera, the smaller the image block size, that is, the more the total number of image blocks, and the better the image adjustment effect. As another example, the greater the resolution of the camera, the greater the image block size. In some embodiments, the size of the image block may be a fixed value or dynamically adjusted.

The processing device 112 may determine a pixel parameter of each image block based on pixel parameters of the one or more pixels in the image block. For example, the processing device 112 may determine an average value of the corresponding pixel parameters of the pixels in an image block as the pixel parameter of the image block. As another example, the processing device 112 may determine a maximum value among the corresponding pixel parameters of the pixels in an image block as the pixel parameter of the image block.

In some embodiments, the pixel parameter of each image block may include a luminance value (Y) and a chroma value (including a red chroma value (R), a green chroma value (G), a blue chroma value (B)). For example, the luminance value of each image block may be an average value or a maximum value of luminance values of pixels in the image block. As another example, the red chroma value of each image block may be an average value of red chroma values of pixels in the image block. In some embodiments, referring to FIG. 6, while recording the pixel parameter (e.g., the luminance value Y_{[i][j]} of any image block, the red chroma value R_{[i][j]}, the green chroma value G_{[i][j]}, and the blue chroma value B_{[i][j]}) of any image block, the processing device 112 may also record a current shutter value and a current gain value of the camera, wherein Y_{[i][j]} represents a luminance value of an image block in the i-th row and j-th column in the captured frame, R_{[i][j]} represents a red chroma value of the image block in the i-th row and j-th column in the captured frame, G_{[i][j]} represents a green chroma value of the image block in the i-th row and j-th column in the captured frame, B_{[i][j]} represents a blue chroma value of the image block in the i-th row and j-th column in the captured frame, i is a positive integer less than or equal to N1, and j is a positive integer less than or equal to N2. Further, the processing device 112 may store the recorded pixel parameter of any image block and the recorded current shutter value and the current gain value of the camera in the storage device 150 for subsequent calls and calculations.

In some embodiments, before determining the pixel parameters of the image blocks, the processing device 112 may monitor whether the camera's shooting parameters change in real time. When the camera's shooting parameters change, the processing device 112 may record the pixel parameters (e.g., the luminance values and/or the chroma values) of the image blocks, and the current shooting parameters of the camera. In some embodiments, the shooting parameter(s) of the camera may include a shutter value, a gain value, an aperture size, sharpness, noise reduction, color saturation, contrast, etc. Merely by way of example, the processing device 112 may monitor parameters of an auto exposure module (AE) and/or an auto white balance (AWB) of an image signal processor (ISP) of the camera. When the AE module and/or the AWB module increase the shutter value and the gain value of the camera, it means that the camera recognizes that the environment becomes dark. At this time, the processing device 112 may record/obtain the pixel parameters (e.g., the luminance values and the chroma values) of the image blocks to avoid wasting resources caused by recording the pixel parameters of the image blocks in real time. In addition, the processing device 112 may also record the current shooting parameters of the camera, such as the current gain value and shutter value of the camera, etc.

In some embodiments, the processing device 112 may determine or record the pixel parameters of the image blocks in real time or periodically. The processing device 112 may further determine the information (also referred to as black block information) of the black block based on the pixel parameters of the image blocks. It should be noted that the information of the black block may also be referred to as information of a plurality of black blocks. In some embodiments, the black block information may comprise at least one of a location, an area (i.e., an area of an image block), or a distribution region of each black block. Specifically, the processing device 112 may determine the luminance value of each image block. The processing device 112 may determine any image block whose luminance value is less than a preset luminance threshold as a black block. That is, the black block may be an image block with a luminance value less than the preset luminance threshold (e.g., less than 15). Further, the processing device 112 may record location information (e.g., the location) of each black block. In some embodiments, the processing device 112 may store the luminance value and/or the location information of each black block in the storage device 150 for subsequent calls.

Merely by way of example, the processing device 112 may traverse the luminance value Y_{[i][j]} of each image block in turn, wherein Y_{[i][j]} represents the luminance value of the image block in the i-th row and j-th column. If Y_{[i][j]}<Y_{darkThr}, wherein Y_{darkThr} represents the preset luminance threshold, the processing device 112 may determine the image block as a black block, and record the location information (e.g., a coordinate value or the location) of the black block. In some embodiments, the location information of the black block may be expressed by which row and column the black block is located in the captured frame. For example, the first to the N2-th image block in each row can be expressed as 0 to (N2−1), and the first to the N1-th image block in each column can be expressed as 0 to (N1−1). The location information of the black block in the first row and the first column can be expressed as {0,0}. Similarly, the location information of the black block in the second row and the second column can be expressed as {1,1}, etc.

In 512, the processing device 112 (e.g., the state judgment module 4901) may determine a state of a camera based on the information of the black block. The state may be one of a normal operation state, a partial masking state, or a full-masking state.

In some embodiments, the processing device 112 may determine a total area of all black blocks and a distribution characteristic of the black blocks based on the area of each image block and the location information of each black block. In some embodiments, the distribution characteristic may include a distribution region, a width of the distribution region, a length of the distribution region, an area of the distribution region, an occlusion area ratio, etc. In some embodiments, the distribution region of the black blocks may include information associated with whether the black blocks are in a boundary region, a non-boundary region, a region of interest, etc.

In some embodiments, when each image block contains the same number of pixels, the area of each image block can be normalized to 1 or any other value. The processing device 112 may determine a total count (or number) of black blocks in the captured frame, and take a product value of the total count (or number) of black blocks and the area of a single image block as the total area occupied by the black blocks in the captured frame. In some embodiments, the processing device 112 may determine only the count of continuously arranged black blocks in the captured frame, and determine the product value of the count of continuously arranged black blocks and the area of a single image block as the total area occupied by the black blocks in the captured frame.

In some embodiments, the processing device 112 may determine the state of the camera based on the total area occupied by black blocks in the captured frame and a preset area condition corresponding to each masking state. For example, The processing device 112 may determine the state of the camera to be the full-masking state in response to the total area of the black blocks and an area of the captured frame satisfying a first area condition. The first area condition may be that the total area of the black blocks is the same as the area of the captured frame. As another example, the processing device 112 may determine the state of the camera to be the partial masking state in response to the total area of the black blocks and the area of the captured frame satisfying a second area condition. The second area condition may be that the total area of the black blocks is less than the area of the captured frame and greater than or equal to a preset area threshold. As a further example, the processing device 112 may determine the state of the camera to be the normal operation state in response to the total area of the black blocks satisfying a third area condition. The third area condition may be that the total area of the black blocks is less than the preset area threshold. In some embodiments, the preset area threshold may be a certain area value or a certain percentage (e.g., 1%, 5%, 10%, etc.) of the area of the captured frame. In some embodiments, the preset area threshold may be set and updated according to the actual situation. The preset area threshold may be smaller than the area of the captured frame.

Taking 1 as the area occupied by a single image block in the captured frame as an example, when the captured frame is divided into 10 rows and 10 columns, that is, the captured frame is divided into 10×10 image blocks, the area of the captured frame is 100. The preset area threshold can set to be 30. When the number of black blocks in the captured frame is 100, and the total area occupied by the black blocks is 100×1, which is equal to the area of the captured frame, it can be determined that the current masking state of the camera is the full-masking state. When the number of black blocks in the captured frame is 70, and the total area occupied by the black block is 70×1 which is smaller than the area of the captured frame and not less than the preset area threshold, it can be determined that the current masking state of the camera is the partial masking state. When the number of black blocks in the captured frame is 10, and the total area occupied by the black blocks is 10×1 which is less than the preset area threshold, it can be determined that the current masking state of the camera is the normal operation state.

In some embodiments, when the camera is in a dark environment or is fully blocked, it is possible for all image blocks in the captured frame to be determined as black blocks. In some special scenarios, for example, when a child is playing with a balloon, and the camera is accidentally blocked by the balloon for an instant, if the state of the camera is immediately determined to be blocked, it may waste resources of the processing device 112 (e.g., the ISP module of the camera). In order to determine the current masking state of the camera more accurately, in response to the total area of the black blocks and the area of the captured frame satisfying the first area condition, and a current shutter parameter (also referred to as a shutter value) and a current gain parameter (also referred to as a gain value) of the camera satisfying a preset parameter condition, the processing device 112 may determine the state to be an initial full-masking state. In some embodiments, in order to reduce computational load and quickly determine the state of the camera, in response to the total area of the black blocks and the area of the captured frame satisfying the first area condition, and the current shutter parameter and the current gain parameter of the camera satisfying the preset parameter condition, the processing device 112 may directly determine the state to be the full-masking state. The preset parameter condition may be that the current shutter parameter and the current gain parameter of the camera reach the correspondingly preset maximum values, respectively. Further, the processing device 112 may start to record a duration of the camera being in the initial full-masking state. In response to the duration of the initial full-masking state being greater than or equal to a preset time (e.g., 2 s, 3 s, 5 s, 10 s, etc.), the processing device 112 may designate the initial full-masking state as the full-masking state. That is, the processing device 112 may determine the current masking state of the camera as the full-masking state. In some embodiments, the preset maximum values corresponding to the shutter parameter and the gain parameter may be a maximum shutter value and a maximum gain value that the camera can achieve by default. Alternatively, the preset maximum values corresponding to the shutter parameter and the gain parameter may be set separately for the shutter value and gain value according to the actual situation.

Merely by way of example, when the camera is just turned on, the current state of the camera is the normal operation state. When Y_{[i][j]}<Y_{darkThr}, gain_{Cur}=gain_{Max}, and shut_{Cru}=shut_{Max}, wherein gain_{Cur} represents the current gain value of the camera, and shut_{Cru} represents the current shutter value of the camera, that is, when the total area occupied by the black blocks in the captured frame is equal to the area of the captured frame, and the current shutter value and gain value of the camera are both the preset maximum values, the processing device 112 may determine that the camera begins to enter the initial full-masking state. The processing device 112 may further add a flag to record a duration of the camera being in the initial full-masking state, but the current state of the camera has not been updated at this time, that is, the state of the camera is still in the normal operation state. Only when stable_{Cnt}≥Countₜₕᵣ, wherein stable_{Cnt} represents the duration of the camera being in the initial full-masking state, and Countₜₕᵣ represents the preset time, the processing device 112 may update the current masking state (i.e., the initial full-masking state) of the camera. The updated current state is the full masking state.

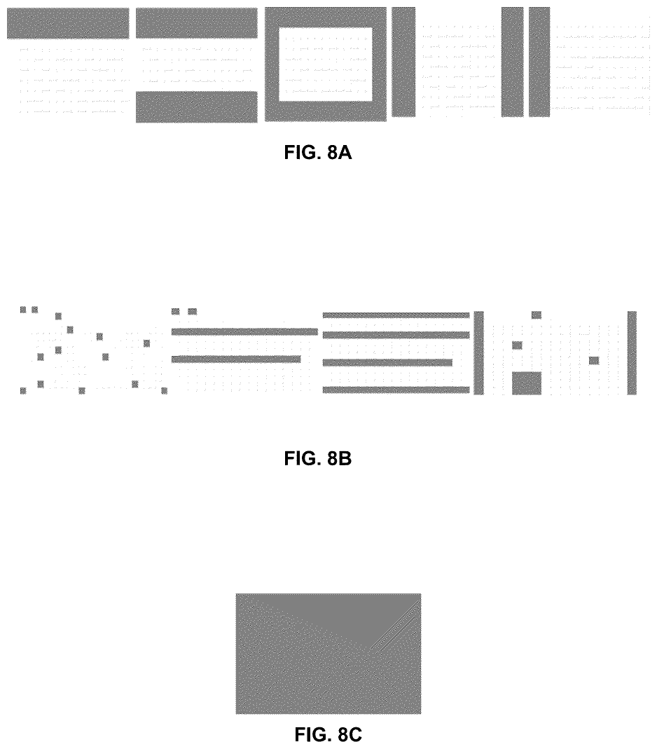

In some embodiments, in response to the total area of the black blocks and the area of the captured frame satisfying the second area condition, the processing device 112 may determine whether the distribution region of the black blocks includes at least one black block row or at least one black block column. In some embodiments, in response to the distribution region of the black block comprising the at least one black block row or at least one black block column, the processing device 112 may directly determine the state of the camera to be the partial masking state. In some embodiments, a long side of the at least one black block row or at least one black block column may coincide with and be equal in length to a side of the captured frame. Specifically, the length of the black block row is the same as the length of the captured frame, and the length of the black block column is the same as the width of the captured frame. In order to determine the current masking state of the camera more accurately, in response to the distribution region of the black blocks comprising the at least one black block row or the at least one black block column (as shown in FIG. 8A and FIG. 8B), a long side of the at least one black block row or at least one black block column coinciding with and being equal in length to a side of the captured frame, and a short side of the at least one black block row or the at least one black block column being greater than or equal to a first preset width, the processing device 112 may determine the state of the camera to be the partial masking state.

Generally, when user need to partially block the camera, the users usually partially block the camera from the edge of the camera, thus when the camera is in the partial masking state, the black blocks always appear at an edge of the captured frame. Therefore, in some embodiments, if the at least one black block row or the at least one black block column is located at any edge of the captured frame, in response to a short side of the at least one black block row or the at least one black block column being greater than or equal to a second preset width, the processing device 112 may determine the state to be the partial masking state. The second preset width may be smaller than the first preset width. It should be noted that the first preset width and the second preset width may be set according to the actual situations. For example, the first preset width may be 40% of the width (or the length) of the captured frame, and the second preset width may be 30% of the width (or the length) of the captured frame.

In some embodiments, in response to the total area of the black blocks satisfying the third area condition and the distribution region of the black blocks satisfying a preset distribution condition, the processing device 112 may determine the state to be the normal operation state. The preset distribution condition may include that no black block row or black block column exists in the distribution region of the black blocks, the distribution region of the black blocks includes the black block row or the black block column and a short side of any of the black block row or the black block column is smaller than the first preset width, or the distribution region of the black blocks includes the black block row or the black block column, the black block row or the black block column is located at any edge of the captured frame, and a short side of the black block row or the black block column is smaller than the second preset width.

In some embodiments, the processing device 112 may determine the state of the camera based on a ratio (i.e., the occlusion area ratio) of the total area occupied by black blocks in the captured frame to the area of the captured frame and a preset ratio range corresponding to each masking state. The preset ratio range corresponding to each masking state may be set according to the actual situations. For example, the preset ratio range corresponding to the normal operation state may be no greater than 0.3, the preset ratio range corresponding to the partial masking state may be greater than 0.3 and less than 1, and the preset ratio range corresponding to the full-masking state may be 1. Furthermore, when the occlusion area ratio is 1, that is, the total area is the same as the area of the captured frame, it can be determined that the current masking state of the camera is the full-masking state. When the occlusion area ratio is 0.7, that is, the total area is less than the area of the captured frame and greater than or equal to the preset area threshold, it can be determined that the current masking state of the camera is the partial masking state. When the occlusion area ratio is 0.1, that is, the total area is less than the preset area threshold, it can be determined that the current masking state of the camera is the normal operation state.

More descriptions regarding the determination of the state of the camera may be found elsewhere in the present disclosure (e.g., FIG. 7 and the descriptions thereof).

In 513, the processing device 112 (e.g., the image adjustment module 4902) may adjust one or more shooting parameters of the camera based on the state of the camera.

Generally, when the camera is in the partial masking state or the full-masking state, the camera may recognize that the environment becomes dark. In order to increase the luminance of the captured frame, the camera's shutter value, gain value, and other shooting parameters may be automatically increased, which may cause problems such as overexposure, white balance color cast, etc., in the captured frame. Therefore, in order to solve the problems of overexposure and white balance color cast in the captured frame, the camera's shooting parameters may be adaptively adjusted based on the current state of the camera. For example, different shooting parameter adjustment strategies may be set for different states of the camera, and the camera's shooting parameters may be adjusted based on the current state of the camera and the shooting parameter adjustment strategy corresponding to the current state of the camera.

Merely by way of example, different shooting parameter adjustment amounts may be set for different states of the camera. According to the current state of the camera and the shooting parameter adjustment amount corresponding to the current state of the camera, the shooting parameter(s), such as the shutter value, the gain value, etc., of the camera may be adjusted. The shooting parameter adjustment amount corresponding to the partial masking state may be greater than the shooting parameter adjustment amount corresponding to the normal operation state and smaller than the shooting parameter adjustment amount corresponding to the full-masking state.

Generally, for a camera is in the normal operation state, when the luminance of the captured frame of the camera is too low, the shutter value and/or gain value of the camera may be automatically increased to improve the luminance of the captured frame, which may cause image problems such as noise, color interference, and dead pixels, affecting the customer experience. Therefore, in some embodiments, in order to eliminate the image problems described above, in response to the state of the camera being the full-masking state, the processing device 112 may determine whether the pixel parameters of the image blocks are greater than a preset value. In response to the pixel parameters being greater than the preset value, the processing device 112 may adjust the shooting parameter(s) until the pixel parameters are less than or equal to the preset value. In some embodiments, the pixel parameter may include a luminance parameter and a chroma parameter. If the current state of the camera is the full-masking state, the processing device 112 may adjust the shooting parameter(s) of the camera until the luminance values and the chroma values of all image blocks in the captured frame are respectively less than or equal to a preset target luminance value threshold and a preset target chroma value threshold. In some embodiments, the shooting parameter(s) of the camera may include a shutter value, a gain value, an aperture size, sharpness, noise reduction, color saturation, contrast, etc.

Merely by way of example, the preset target luminance value threshold is Y_{successThr}, and the preset target chroma value threshold includes a target red chroma value threshold R_{successThr}, a target green chroma value threshold G_{successThr}, and a target blue chroma value threshold B_{successThr}. When the current state of the camera is the full-masking state, the processing device 112 may adjust the camera's shooting parameters through the ISP module, such as reducing the gain value, reducing sharpness, increasing noise reduction, reducing color saturation, adjusting contrast, etc., until the luminance value Y_{[i][j]}≤Y_{successThr}, the red chroma value R_{[i][j]}≤R_{successThr}, the green chroma value G_{[i][j]}≤G_{successThr}, and the blue chroma value B_{[i][j]}≤B_{successThr}. That is, the luminance value and chroma value of any image block are less than or equal to the preset target luminance value threshold and the preset target chroma value threshold, respectively. Y_{[i][j]} represents the luminance value of the image block in the i-th row and j-th column, R_{[i][j]} represents the red chroma value of the image block in the i-th row and j-th column, G_{[i][j]} represents the green chroma value of the image block in the i-th row and j-th column, and B_{[i][j]} represents the blue chroma value of the image block in the i-th row and j-th column.

In some embodiments, in order to improve adjustment efficiency, for any shooting parameter, a target value of the shooting parameter (also referred to as a target shooting parameter) may be determined based on the pixel parameters of the image blocks, target pixel parameters of the image blocks, and the current shooting parameter of the camera. Thus, the processing device 112 may adjust the current value of the shooting parameter of the camera to be the target value directly to improve the adjustment efficiency.

In some embodiments, the target pixel parameters of the image blocks may be determined based on an adjustment requirement. The adjustment requirement may reflect the user's requirement for the image quality under the full-masking state. For example, if the user needs the captured frame to be very clean, which is the same as a picture of the camera when the camera is turned off, the target pixel parameters of the image blocks may be very low. But if the user does not have such a high requirement, the target pixel parameters of the image blocks do not need to be very low, and the captured frame may be quickly adjusted to the desired state. In some embodiments, the adjustment requirement may be reflected by an adjustment level, for example, the higher the adjustment level, the higher the requirement for the image quality of the adjusted frame. Specifically, the processing device 112 may retrieve the target pixel parameters of the image blocks from a preset table based on the adjustment level. The preset table may include a corresponding relationship between target pixel parameters of the image blocks and the adjustment level.

In some embodiments, the target value of the shooting parameter may be determined based on a shooting parameter determination model. The processing device 112 may input the pixel parameters of the image blocks, target pixel parameters of the image blocks, and the current shooting parameter into the shooting parameter determination model to determine the target value of the shooting parameter. The shooting parameter determination model may be trained based on a plurality of groups of training data. Each group of training data may include sample pixel parameters of all the image blocks, the corresponding sample target pixel parameters of the image blocks, a sample current shooting parameter, and a corresponding reference target value of the shooting parameter, and during the training, the corresponding reference target value of the shooting parameter may be used as a label.

In some embodiments, in response to the state of the camera being the partial masking state, the processing device 112 may determine a first luminance average of the captured frame based on the luminance parameters of the black blocks and the luminance parameters of non-black blocks of the captured frame. The processing device 112 may adjust the shooting parameter of the camera (e.g., the shutter value and the gain value of the AE module) to adjust an exposure level of the camera based on the first luminance average. That is to say, the processing device 112 may adjust the captured frame by controlling the exposure level of the camera through the AE module based on the first luminance average to improve the accuracy of the AE module in adjusting the luminance of the captured frame and improve the quality of the captured frame. It should be noted that in the present disclosure, the adjustment of the captured frame refers that adjusting one or more shooting parameters of the camera to update the current frame with poor image quality to the next frame with good image quality.

In some embodiments, the processing device 112 may further determine a first chroma sum value based on chroma parameters of the non-black blocks. The processing device 112 may adjust the captured frame by controlling e.g., the AWB module, based on the first chroma sum value to ensure that the non-blocked region does not exhibit color cast or other problems. More descriptions regarding the adjustment of the shooting parameter(s) of the camera when the state of the camera is the partial masking state may be found elsewhere in the present disclosure (e.g., FIG. 5B and the descriptions thereof).

In some embodiments, in response to the state of the camera being the normal operation state, and before the normal operation state, the state of the camera being the full-masking state or the partial masking state, that is, the state of the camera changes from the full-masking state or the partial masking state to the normal operation state, the processing device 112 may restore the shooting parameter to its corresponding default value. Specifically, the processing device 112 may cancel the adjustment of the shooting parameters of the camera and the adjustment of the captured frame, that is, cancel the reduction of the gain value and shutter value, and cancel the adjustment of parameters such as sharpness, noise reduction, color saturation, contrast, DCP intensity, etc., by the ISP module. For example, the processing device 112 may implement the cancellation operation through a recovery module. That is to say, the shooting parameters may adopt image adjustment methods in related technologies. For example, when the camera recognizes that the environment becomes dark, the processing device 112 or the ISP module may increase the gain value to the maximum value, thereby improving the luminance of the captured frame, and improving the user experience.

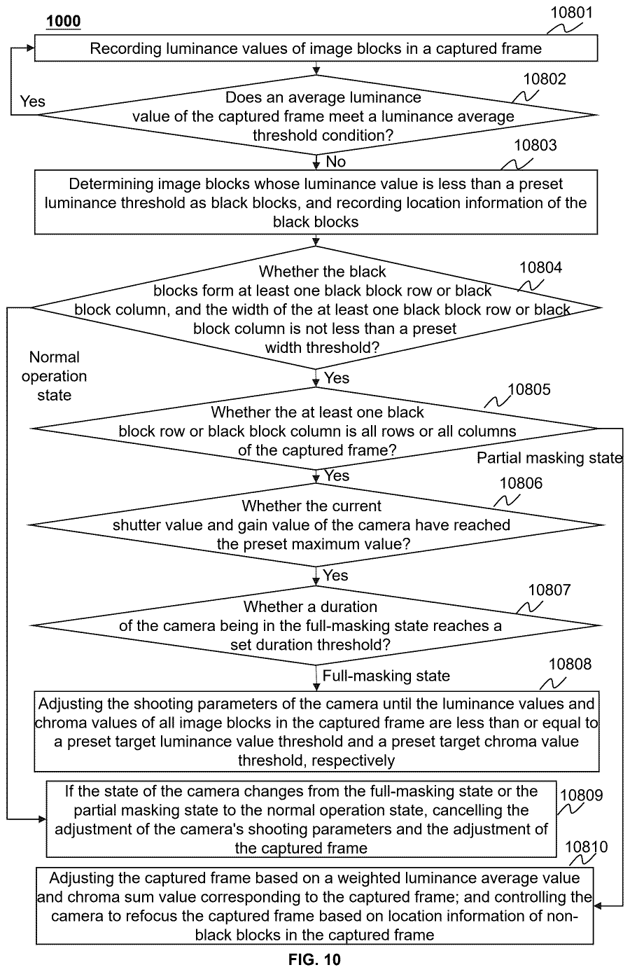

Further, the processing device 112 may restore the adjustment mode of the AE module, the AWB module, and the AF module to normal adjustment. More descriptions regarding the adjustment of the shooting parameter(s) of the camera may be found elsewhere in the present disclosure (e.g., FIG. 5B, FIG. 9, and FIG. 10 and the descriptions thereof).

In some embodiments, the process 500A may further include an operation of emitting sound when the state of the camera is in the partial masking state or the full-masking state.

FIG. 5B is a flowchart illustrating an exemplary process for image adjustment according to some embodiments of the present disclosure. In some embodiments, process 500B may be performed to achieve at least part of operations 512-513 as described in connection with FIG. 5A.

In 521, in response to a state of a camera being the partial masking state, the processing device 112 (e.g., the image adjustment module 4902) may determine a first luminance average of the captured frame of the camera based on luminance parameters of black blocks and luminance parameters of non-black blocks of non-black blocks of the captured frame.

As used herein, a non-black block refers to any image block whose luminance value is less than the preset luminance threshold. In some embodiments, the processing device 112 may determine a luminance average value of all black blocks in the captured frame based on the luminance parameters (i.e., the luminance values) of the black blocks and a luminance average value of all non-black blocks in the captured frame based on the luminance parameters (i.e., luminance values) of the non-black blocks. The processing device 112 may determine the first luminance average by averaging the luminance average value of the black blocks and the luminance average value of the non-black blocks.

In some alternatively embodiments, the processing device 112 may determine a weighted luminance average value of the captured frame based on the luminance parameters (or luminance values) of the black blocks, the luminance parameters (or luminance values) of the non-black blocks, a first weight coefficient corresponding to the black blocks, and a second weight coefficient corresponding to the non-black blocks in the captured frame as the first luminance average of the captured frame. Since the region where the non-black blocks are located is the main surveillance region, in order to reduce the impact of the region where the black blocks are located on the first luminance average of the captured frame, the second weight coefficient may be greater than the first weight coefficient. For example, the processing device 112 may determine a luminance average value of the non-black blocks based on the luminance parameters (or luminance values) of the non-black blocks, and a luminance average value of the black blocks based on the luminance parameters (or luminance values) of the black blocks. The first weight coefficient corresponding to the black blocks is b, and the second weight coefficient corresponding to the non-black blocks is a. A sum of the first weight coefficient b and the second weight coefficient a is 1. The weighted luminance average value of the captured frame may be determined according to the following Equation (1):

$${Y}_{Avg} = a \times {Y}_{evA} + b \times {Y}_{evB} , \qquad ( 1 )$$

where, Y_{Avg} denotes the weighted luminance average value corresponding to the captured frame, Y_{evA} denotes the luminance average value of the non-black blocks in the captured frame, and Y_{evB} denotes the luminance average value of the black blocks in the captured frame.

In some embodiments, the first weight coefficient and the second weight coefficient may correlate to a distribution characteristic of the black blocks and an environmental characteristic of the captured frame. In some embodiments, the distribution characteristic may include a distribution region, a distribution width, a distribution length, a distribution area, an occlusion area ratio, or the like, or any combination thereof. Merely by way of example, the distribution characteristic of the black blocks may be expressed as a vector. The vector may include multiple elements such as the top side, width of occlusion at top side, down side, width of occlusion at down side, left side, width of occlusion at left side, right side, width of occlusion at right side, and occlusion area ratio. For example, a vector (1,1,0,0,1,3,0,0,0.4) of the distribution characteristic of the black blocks may represent that there is occlusion at the top side of the captured frame and the corresponding width is 1; there is no occlusion at the down side; there is occlusion at the left side and the corresponding width is 3; there is no occlusion at the right side; and the occlusion area ratio is 40%.

In some embodiments, the environmental characteristic of the captured frame may include a backlight scene, a night scene (dark scene), a normal light scene, etc. The determination of the environmental characteristic of the captured frame may be based on an image classification technology. For example, the environmental characteristic of the captured frame may be determined using a convolutional neural network (CNN) model, a machine learning model, etc., which may not be described in detail in this present disclosure.

In some embodiments, the processing device 112 may retrieve the first weight coefficient and the second weight coefficient from a weight coefficient database based on the distribution characteristic of the black blocks and the environmental characteristic of the captured frame. The weight coefficient database may include a corresponding relationship among the first weight coefficient, the second weight coefficient, the distribution characteristic of the black blocks, and the environmental characteristic of the captured frame. The first weight coefficient and the corresponding second weight coefficient may be weights corresponding to the captured frame with the best effect after being adjusted by the AE module. After the distribution characteristic of the black blocks and the environmental characteristic of the captured frame are determined, the processing device 112 may determine the first weight coefficient and the second weight coefficient by retrieving the weight coefficient database based on the determined distribution characteristic of the black blocks and the determined environmental characteristic of the captured frame.

In some embodiments, the luminance average value of the non-black blocks of the captured frame may be determined based on a weighted summation. The weighted summation may be determined based on the luminance parameters of a plurality of sub-regions of a non-blocked region (i.e., a region where the non-black blocks are located). The plurality of sub-regions may be determined based on grouping image blocks in the non-blocked region.

In some embodiments, the plurality of sub-regions may be determined based on a preset grouping rule. For example, each image block in the non-blocked region may be determined as a sub-region. As another example, an image block row or an image block column may be determined as a sub-region. As a further example, the processing device 112 may determine multiple rectangles (or quasi-circles) with different side lengths (or radii) centered on a center of the non-blocked region. A region between two adjacent rectangles (or quasi-circles) may be determined as a sub-region.

The processing device 112 may determine a distance between each sub-region and the center of the non-blocked region as the weight of each sub-region. The center of the non-blocked region may be determined based on the location information of all the non-black blocks. For example, the processing device 112 may identity two image blocks that are furthest apart in the non-blocked region based on the location information of all the non-black blocks. The processing device 112 may determine the center point between the two image blocks as the center of the non-blocked region.

Merely by way of example, the processing device 112 may obtain a relationship among the distance between each sub-region and the center of the non-blocked region, and the weights of the plurality of sub-regions. The processing device 112 may determine the weights of the plurality of sub-regions based on the distances and the relationship. The closer the sub-region is to the center of the non-blocked region, the greater the weight. The further away from the center, the smaller the weight. The sub-region corresponding to the center of the non-blocked region may have the largest weight. According to some embodiments of the present disclosure, by comprehensively considering the luminance parameters (i.e., luminance values) of different sub-regions in the non-blocked region, the obtained luminance average value of the non-black blocks can be more accurate, thereby improving the accuracy of the first luminance average of the captured frame, and improving the quality of the captured frame.

In some embodiments, the plurality of sub-regions may be determined based on pixel parameters of the image blocks in the non-blocked region, and the weights of the plurality of sub-regions may be determined based on feature vectors and/or area ratios of the plurality of sub-regions. Specifically, the processing device 112 may determine a feature vector corresponding to each sub-region based on the pixel parameter (e.g., the luminance value and the chroma value) of the sub-region. Merely by way of example, the processing device 112 may cluster the feature vectors of the plurality of sub-regions to determine multiple clusters. Each cluster may be determined as a sub-region. Further, the processing device 112 may determine the feature vector at the center of the cluster as the feature vector of the sub-region, and determine a ratio of an area of each sub-region to the total area of the non-blocked region as the area ratio of the sub-region. The processing device 112 may determine the area ratios of the plurality of sub-regions as the weights of the plurality of sub-regions directly. The greater the area ratio, the greater the weight.

In some embodiments, the processing device 112 may determine the weights of the plurality of sub-regions based on a weight prediction model. The processing device 112 may input the feature vectors and area ratios of the plurality of sub-regions into the weight prediction model to determine the weights of the plurality of sub-regions. The weight prediction model may be trained based on a plurality of groups of training data. Each group of training data may include a sample feature vector of a sample sub-region, a corresponding sample area ratio of the sample sub-region, and a corresponding reference weight of the sample sub-region, and during the training, the corresponding reference weight of the sample sub-region may be used as a label. Specifically, for a sample sub-region in a sample non-blocked region, the processing device 112 may determine the sample feature vector and the corresponding sample area ratio of the sample sub-region in a manner similar to the above-described manner of determining the feature vectors and/or area ratios of the plurality of sub-regions. The processing device 112 may keep other weights and parameters unchanged, and randomly take a large number of values for the weight of each sample sub-region. The processing device 112 may perform automatic exposure, and determine the corresponding weight with the best (or qualified) automatic exposure effect as the label.

In some embodiments, since the edge of the non-blocked region often appears blurred or has abnormal color due to refraction, diffraction of light, etc., the plurality of sub-regions may include a boundary region and a non-boundary region. As used herein, the boundary region refers to a region in the non-blocked region between the non-blocked region and a blocked region (i.e., a region where the black blocks are located), which has a certain distance to the blocked region. The non-boundary region refers to a region other than the boundary region in the non-blocked region. The processing device 112 may determine the weights of the boundary region and the non-boundary region based on a prediction model. Specifically, the prediction model may include a sub-region determination layer (e.g., CNN layer) and a weight determination layer. During the training, the input of the sub-region determination layer may include sample pixel parameters of all image blocks in a sample captured frame and corresponding sample pixel parameters of the sample non-blocked region, and the output of the sub-region determination layer may include sample image blocks contained in the boundary region, sample image blocks contained in the non-boundary region, wherein the label may be manually annotated tags, that is, labelling a reference boundary region and a reference non-boundary region on the sample captured frame. The output data of the sub-region determination layer may be the input data of the weight determination layer. Specifically, the input of the weight determination layer may include pixel parameters of the sample image blocks contained in the boundary region and pixel parameters of the sample image blocks contained in the non-boundary region, and the output of the weight determination layer may include a weight of the reference boundary region and a weight of the reference non-boundary region, wherein the label may be determined in a manner similar to the above-described manner of determining the label of the weight prediction model. According to some embodiments of the present disclosure, by comprehensively considering the characteristic of the boundary region in the non-blocked region, the impact of the blurred boundary region on the determination of the luminance average value of the non-black blocks can be reduced, thus the obtained luminance average value of the non-black blocks can be more accurate, thereby improving the accuracy of the first luminance average of the captured frame, and improving the quality of the captured frame.

In some embodiments, the plurality of sub-regions may include a region of interest and a region of non-interest. For a fixed camera, the monitoring region is generally relatively fixed, and some things (such as furniture, decorations, etc.) are also fixed. Thus, images (static objects) monitored by the fixed camera under the partial masking state are very similar to those under the normal operation state in the most recent historical time. In such cases, by comparing the images in the two situations, a region with relatively great differences can be determined as a region of interest. In some embodiments, the region of interest may be a region where a target object (e.g., a person, an animal, etc.) is located.

The processing device 112 may determine weights of the region of interest and the region of non-interest in a manner similar to the above-described manner of determining the weight of the boundary region and the weight of the non-boundary region based on the prediction model. According to some embodiments of the present disclosure, by dividing the non-blocked region into the region of interest and the region of non-interest and determining the luminance average value of the non-black blocks based on the region of interest and the region of non-interest, the captured frame can represent the region of interest with better image quality, thereby improving user experience.

In 522, the processing device 112 (e.g., the image adjustment module 4902) may determine a first chroma sum value based on chroma parameters of the non-black blocks.

Merely by way of example, the processing device 112 may obtain the red chroma values, green chroma values, and blue chroma values of all the non-black blocks in the captured frame. The processing device 112 may determine an accumulated sum of the calculated chroma values as the chroma sum value of the captured frame. The red chroma sum value of the captured frame is Sum_{R}, the blue chroma sum value is Sum_{B}, and the green chroma sum value is Sum_{G}. The processing device 112 may save a ratio of the red chroma sum value to the green chroma sum value (i.e., Gr=Sum_{R}/Sum_{G}) and a ratio of the blue chroma sum value to the green chroma sum value (i.e., Gb=Sum_{B}/Sum_{G}) to the storage device 150 (e.g., a memory of the ISP module), so that the subsequent AWB module can adjust the captured frame according to Gr and Gb, thereby solving the problem of color cast in regions where non-black blocks are located in the captured frame.

In 523, the processing device 112 (e.g., the image adjustment module 4902) may adjust the shooting parameter of the camera based on the first luminance average and the first chroma sum value.

In some embodiments, the processing device 112 may adjust the shooting parameter of the camera (e.g., the shutter value, the gain value, etc., of the AE module) to adjust an exposure level of the camera based on the first luminance average to improve the accuracy of the AE module in adjusting the luminance of the subsequent captured frames and improve the quality of the subsequent captured frames. It should be noted that in the present disclosure, the adjustment of the captured frame refers that adjusting one or more shooting parameters of the camera to update the current frame with poor image quality to the next frame with good image quality.

In some embodiments, the processing device 112 may adjust the shooting parameter of the camera (e.g., the white balance value, the color saturation, etc., of the AWB module) based on the first chroma sum value to ensure that the non-blocked region does not exhibit color cast or other problems.

In some embodiments, the processing device 112 may adjust the captured frame by controlling e.g., the AE module and the AWB module, based on the first luminance average and the first chroma sum value, so as to improve the accuracy of the AE module in adjusting the luminance value of the captured frame, improve the quality of the captured frame, and ensure that the non-blocked region does not exhibit color cast or other problems.

In some embodiments, since the color and/or luminance of the boundary region may be abnormal, so the color information and/or the luminance information of the boundary region needs to be ignored or weakened to improve the accuracy of the adjustment of the shooting parameters of the camera. The processing device 112 may determine a second luminance average and a second chroma sum value for the non-boundary region of the captured frame. The processing device 112 may adjust the shooting parameter of the camera based on the first luminance average, the first chroma sum value, the second luminance average, and the second chroma sum value, to reduce color interference caused by occlusion and improve white balance effect of the camera.

In some embodiments, in order to make the focus effect of the camera better, when the current state of the camera is the partial masking state, the processing device 112 may record location information of the non-black blocks in the captured frame. The processing device 112 may control the camera to refocus based on the location information of the non-black blocks. For example, the processing device 112 may utilize an automatic focus (AF) module to control the camera to refocus on regions where the non-black blocks are located in the captured frame to improve focusing accuracy. In some embodiments, in order to exclude blurred boundary regions or non-interesting regions, and further improve the accuracy and speed of focusing, the processing device 112 may determine the non-boundary region and the region of interest in the non-blocked region based on the location information of the non-black blocks. The processing device 112 may control the camera to refocus the non-boundary region or the region of interest.

In some embodiments, the process 500B may further include an operation of emitting sound when the state of the camera is in the partial masking state.

FIG. 7 is a flowchart illustrating an exemplary process for determining a state of a camera according to some embodiments of the present disclosure. In some embodiments, process 700 may be performed to achieve at least part of operations 511-512 as described in connection with FIG. 5A.

In 7601, the processing device 112 (e.g., the state judgment module 4901) may determine a luminance value of each image block in a captured frame of a camera.

When the AE module starts to adjust the shutter value and gain value of the camera, the processing device 112 may start to record the luminance value of each image block in the camera's captured frame.

In 7602, the processing device 112 (e.g., the state judgment module 4901) may determine whether a luminance average value of the captured frame meets a luminance average threshold condition.

The luminance average threshold condition may be a condition indicating whether the luminance average value of the captured frame reaches a preset target luminance value. That is to say, the luminance average threshold condition may be a condition indicating whether the exposure level of the camera in the current state is in a normal stable state. According to the luminance values of all image blocks in the captured frame, the processing device 112 may determine the luminance average value of the captured frame. If the luminance average value of the captured frame does not meet the luminance average threshold condition, it means that the luminance value of the captured frame changes greatly and exceeds an expected range, and the captured frame needs to be adjusted. In response to a determination that the luminance average value of the captured frame does not meet the luminance average threshold condition, the processing device 112 may proceed to perform operation 7603. When the luminance average value of the captured frame meets the luminance average threshold condition, it means that the change in luminance value of the captured frame does not exceed an expected range, and there is no need to adjust the captured frame, then the processing device 112 may return to perform operation 7601.

Merely by way of example, the luminance average value of the captured frame may be determined according to the following equation:

$${Y}_{avg} = {\sum }_{i = 1}^{Row} {\sum }_{j = 1}^{Col} {Y}_{[ i , j ]} / ( Row * Col )$$

where, Y_{avg} denotes the luminance average value corresponding to the captured frame, Y_{[i,j]} denotes the luminance value of the image block in the i-th row and j-th column, Row denotes a count of rows in the captured frame, and Col denotes a count of columns in the captured frame.

The luminance average threshold condition may be a condition of |Y_{avg}−Y_{tag}|≤Yₜₕᵣ. That is, the luminance average value of the captured frame should be adjusted to be within a range of (Y_{tag}−Yₜₕᵣ) to (Y_{tag}+Yₜₕᵣ). When the condition of |Y_{avg}−Y_{tag}|≤Yₜₕᵣ is not met, it can be considered that the luminance average value of the captured frame does not meet the luminance average threshold condition, the processing device 112 may proceed to perform operation 7603, wherein Y_{tag} represents the preset target luminance value and Yₜₕᵣ represents a preset luminance tolerance threshold.

Optionally, if the camera has just been turned on, the camera is initialized, that is, the state of the camera is the normal operation state. The processing device 112 may monitor the AE module in real time. When the AE module starts to adjust the shutter value and the gain value, the processing device 112 may start to record luminance values and chroma values of image blocks in the camera's captured frame. The processing device 112 may calculate the luminance average value of the captured frame. When the condition |Y_{avg}−Y_{tag}|≤Yₜₕᵣ is not met, the processing device 112 may adjust the shutter value and the gain value of the camera until the luminance average value of the captured frame satisfies |Y_{avg}−Y_{tag}|≤Yₜₕᵣ.

In 7603, the processing device 112 (e.g., the state judgment module 4901) may determine image blocks whose luminance values are less than a preset luminance threshold as black blocks and record location information of the black blocks.

In 7604, the processing device 112 (e.g., the state judgment module 4901) may determine whether the black blocks form at least one black block row or at least one black block column and the width of the black block row or the black block column is greater than or equal to a preset width threshold.

If there is a black block row or a black block column, and the width of the black block row or the black block column is greater than or equal to the preset width threshold, the processing device 112 may proceed to perform operation 7605. Otherwise, the current state of the camera may be determined to be the normal operation state. The processing device 112 may adjust a shooting parameter of the camera in connection with operation 513 in FIG. 5A.

In 7605, the processing device 112 (e.g., the state judgment module 4901) may determine whether the at least one black block row or the at least one black block column is all rows or all columns of the captured frame.

If the at least one black block row or the at least one black block column is all rows or all columns of the captured frame, the processing device 112 may proceed to perform operation 7606. Otherwise, the current state of the camera may be determined to be the partial masking state. The processing device 112 may adjust the shooting parameter of the camera in connection with operation 513 in FIG. 5A or operations 521-523 in FIG. 5B.

In 7606, the processing device 112 (e.g., the state judgment module 4901) may determine whether the current shutter value and gain value of the camera reach the corresponding preset maximum values, respectively.

In response to a determination that the current shutter value and gain value of the camera reach the preset maximum values, the processing device 112 may consider that the camera enters an initial full-masking state, and start to record a duration of the camera being in the initial full-masking state. Then the processing device 112 may proceed to perform operation 7607. Otherwise, the processing device 112 may return to perform operation 7601.

In 7607, the processing device 112 (e.g., the state judgment module 4901) may determine whether the duration of the camera being in the full-masking state reaches a preset duration threshold.

In response to a determination that the duration of the camera being in the full-masking state reaches the preset duration threshold, the processing device 112 may determine that the current masking state of the camera is the full-masking state. The processing device 112 may adjust the shooting parameter of the camera in connection with operation 513 in FIG. 5A. Otherwise, the processing device 112 may return to perform operation 7601.

More descriptions regarding the determination of the black blocks and the state of the camera may be found elsewhere in the present disclosure, e.g., operations 511-512 in FIG. 5A and the descriptions thereof.

FIG. 8A is a schematic diagram illustrating exemplary frames captured by a camera when the camera is in a partial masking state according to some embodiments of the present disclosure. A preset width threshold may be equal to twice the width of an image block. As shown in FIG. 8A, from left to right, the first captured frame contains a black block row, and the width of the black block row is greater than the preset width threshold; the second captured frame contains two black block rows, and the width of at least one black block row is greater than the preset width threshold; the third captured frame includes two black block rows and two black block columns, and there is at least one black block row or at least one black block column whose width is not less than the preset width threshold; the fourth captured frame contains two black block columns, and the width of at least one black block column is greater than the preset width threshold; the fifth captured frame contains a black block column, and the width of the black block column is greater than the preset width threshold. When the camera is in the partial masking state, the rows or columns of black blocks in the captured frame may be located around the captured frame, that is, the black blocks that satisfy the condition Y_{[i][j]}<Y_{darkThr} are distributed around the captured frame. It should be understood that the embodiments of the present disclosure only illustrate the captured frames in the partial masking state, and the actual situation is not limited to the above five situations.

In addition, if there are no black block rows or black block columns, the processing device 112 may determine that the current state of the camera is the normal operation state. If there is a black block row or black block column, and the black block row or black block column whose width is greater than the preset width threshold is located around the captured frame, the processing device 112 may determine that the current state of the camera is the partial masking state. If there is a black block row or black block column, but the black block row or black block column is not located around the captured frame, the processing device 112 may determine that the current state of the camera is the normal operation state.

FIG. 8B is a schematic diagram illustrating an exemplary frame captured by a camera when the camera is in a normal operation state according to some embodiments of the present disclosure. A preset width threshold may be equal to twice the width of an image block. As shown in FIG. 8B, from left to right, there are no black block rows and black block columns in the first captured frame; the second captured frame contains a black block row, but the width of the black block row is smaller than the preset width threshold; the third captured frame contains three black block rows, but the width of any black block row is smaller than the preset width threshold; the fourth captured frame contains two black block columns, but the width of any black block column is smaller than the preset width threshold. That is, as shown in the first captured frame, the black blocks that satisfy the condition Y_{[i][j]}<Y_{darkThr} do not constitute a black block row or a black block column; as shown in the second captured frame, the width of the black block row or black block column in the second captured frame is smaller than the preset width threshold and the black block row or black block column in the captured frame is not located around the captured frame; as shown in the third and fourth captured frames, the width of the surrounding black block row or black block column in the captured frame is smaller than the preset width threshold. When the number of black blocks in the captured frame is too small, it can have little impact on the image effect. Thus, the camera may be judged as in the normal operation state and no processing is required.

FIG. 8C is a schematic diagram illustrating an exemplary frame captured by a camera when the camera is in a full-masking state according to some embodiments of the present disclosure. As shown in FIG. 8C, the black block rows in the captured frame are all the rows in the captured frame, or the black block columns in the captured frame are all the columns in the captured frame. That is to say, all image blocks in the captured frame are black blocks. Therefore, the current masking state of the camera corresponding to the captured frame is the full-masking state.

That is to say, the black blocks that satisfy the condition Y_{[i][j]}<Y_{darkThr} cover the entire captured frame, and at this time, the shutter value and gain value reach the preset maximum value, that is, three conditions gain_{Cur}=gain_{Max}, shut_{Cru}=shut_{Max}, Y_{[i][j]}<Y_{darkThr} are met. In some embodiments, the processing device 112 may perform stability judgment on the above three conditions, that is, the stable_{Cnt} flag is added. Only when the condition stable_{Cnt}>=Countₜₕᵣ is satisfied, the processing device 112 can determine that the current masking state of the camera is the full-masking state. In this case, image adjustment needs to be made so that the adverse effects can be eliminated even when the camera is blocked by the user, thereby meeting the user's needs.

FIG. 9 is a flowchart illustrating an exemplary process for image adjustment according to some embodiments of the present disclosure. In some embodiments, process 900 may be performed to achieve at least part of operations 512-513 as described in connection with FIG. 5A.

In 9710, the processing device 112 (e.g., the image adjustment module 4902) may determine a current state of the camera.

In response to a determination that the current state of the camera is the full-masking state, the processing device 112 may proceed to perform operation 9720. In response to a determination that the current state of the camera is the partial masking state, the processing device 112 may proceed to perform operation 9730. In response to a determination that the current state of the camera is the normal operation state, the processing device 112 may proceed to perform operation 9740.

In 9720, the processing device 112 (e.g., the image adjustment module 4902) may determine whether the luminance value and the chroma value of each image block in the captured frame are less than or equal to the preset target luminance value threshold and the preset target chroma value threshold.

In response to a determination that the luminance values and the chroma values of image blocks in the captured frame are less than or equal to the preset target luminance value threshold and the preset target chroma value threshold, the processing device 112 may return to perform operation 9710. Otherwise, the processing device 112 may proceed to perform operation 9721.

In 9721, the processing device 112 (e.g., the image adjustment module 4902) may reduce the gain value of the camera to reduce the luminance value of the captured frame.

In 9722, the processing device 112 (e.g., the image adjustment module 4902) may reduce the sharpness and enhance noise reduction to reduce noise in the captured frame.

In 9723, the processing device 112 (e.g., the image adjustment module 4902) may reduce color saturation to reduce color interference in the captured frame.

In 9724, the processing device 112 (e.g., the image adjustment module 4902) may adjust the contrast and adjust the captured frame to be consistent with the picture when the camera is not turned on.

In 9725, the processing device 112 (e.g., the image adjustment module 4902) may perform a defective pixel correction (DPC) operation on the captured frame. That is, the processing device 112 may increase the correction intensity of bad pixels.

In 9730, the processing device 112 (e.g., the image adjustment module 4902) may obtain location information of black blocks in the captured frame. The processing device 112 may perform operations 97310, 97320, and 97330 simultaneously or sequentially.

In 97310, the processing device 112 (e.g., the image adjustment module 4902) may adjust the captured frame through the AE module.

In 97311, the processing device 112 (e.g., the image adjustment module 4902) may calculate the luminance average value Y_{evA} of the non-blocked region in the captured frame. That is, the luminance average value Y_{evA} of all non-black blocks in the captured frame is calculated.

In 97312, the processing device 112 (e.g., the image adjustment module 4902) may calculate the luminance average value Y_{evB} of the blocked region in the captured frame. That is, the luminance average value Y_{evB} of all black blocks in the captured frame is calculated.

In 97313, the processing device 112 (e.g., the image adjustment module 4902) may determine the weighted luminance average value of the captured frame.

In some embodiments, the weighted luminance average value of the captured frame may be determined according to the abovementioned Equation (1) described in FIG. 5A.

In 97320, the processing device 112 (e.g., the image adjustment module 4902) may adjust the captured frame through the AWB module.

In 97321, the processing device 112 (e.g., the image adjustment module 4902) may record the chroma values of the non-black blocks in the captured frame. For example, the processing device 112 may record the red chroma value R_{[i][j]}, green chroma value G_{[i][j]}, and blue chroma value B_{[i][j]} of any non-black block in the captured frame.

In 97322, the processing device 112 (e.g., the image adjustment module 4902) may determine the chroma sum value of the captured frame based on the chroma values of the non-black blocks. That is to say, the processing device 112 may calculate the sum of red chroma values Sum_{R}, green chroma value Sum_{G}, and blue chroma value Sum_{B} of all non-black blocks in the captured frame, and determine the calculated Sum_{R}, Sum_{G}, and Sum_{B} as the chroma sum value of the captured frame.

In 97323, the processing device 112 (e.g., the image adjustment module 4902) may calculate Gr and Gb, wherein Gr=Sum_{R}/Sum_{G} and Gb=Sum_{B}/Sum_{G}.

In 97324, the processing device 112 (e.g., the image adjustment module 4902) may set Gr and Gb to the ISP module. The processing device 112 may adjust the captured frame based on Gr and Gb through the AWB module of the ISP module.

In 97330, the processing device 112 (e.g., the image adjustment module 4902) may adjust the captured frame through the AF module.

In 97331, the processing device 112 (e.g., the image adjustment module 4902) may record the location information of the non-black blocks, and control the camera to refocus by the AF module based on the location information of the non-black blocks in the captured frame.

In 9740, the processing device 112 (e.g., the image adjustment module 4902) may restore the gain value to default value. That is, the gain value may not be adjusted.

In 9741, the processing device 112 (e.g., the image adjustment module 4902) may restore the shooting parameters in the ISP module to default values. That is, the shooting parameters may not be adjusted. The shooting parameters may include shutter value, sharpness, noise reduction, color saturation, contrast, DCP intensity, etc.

In 9742, the processing device 112 (e.g., the image adjustment module 4902) may restore the AE module. That is to say, the processing device 112 may adjust the captured frame through the AE module based on the luminance value of the captured frame, rather than based on the weighted luminance average value of the captured frame.

In 9743, the processing device 112 (e.g., the image adjustment module 4902) may restore the AWB module. That is to say, the processing device 112 may adjust the captured frame through the AWB module based on the chroma sum value corresponding to the captured frame, rather than based on the chroma sum value corresponding to non-black blocks of the captured frame.

In 9744, the processing device 112 (e.g., the image adjustment module 4902) may restore the AF module. That is to say, the processing device 112 may focus the captured frame through the AF module based on all regions of the captured frame, rather than based on the location information of non-black blocks of the captured frame.

More descriptions regarding the determination of the state of the camera and the adjustment of the shooting parameter of the camera may be found elsewhere in the present disclosure, e.g., operations 512-513 in FIG. 5A and operations 521-523 in FIG. 5B, and the descriptions thereof.

FIG. 10 is a flowchart illustrating an exemplary process for image adjustment according to some embodiments of the present disclosure. In some embodiments, process 1000 may be performed to achieve at least part of operations 511-513 as described in connection with FIG. 5A.

In 10801, the processing device 112 (e.g., the image adjustment module 4902) may record luminance values of image blocks in a camera's captured frame.

In 10802, the processing device 112 (e.g., the image adjustment module 4902) may determine whether the luminance average value of the captured frame meets the luminance average threshold condition. Specifically, the processing device 112 may determine the luminance average value of the captured frame based on all image blocks in the captured frame. In response to a determination that the luminance average value of the captured frame does not meet the luminance average threshold condition, the processing device 112 may proceed to perform operation 10803. Otherwise, the processing device 112 may return to perform operation 10801.

In 10803, the processing device 112 (e.g., the image adjustment module 4902) may determine image blocks with luminance values less than the preset luminance threshold as black blocks, and record the location information of the black blocks.

In 10804, the processing device 112 (e.g., the image adjustment module 4902) may determine whether the black blocks form at least one black block row or at least one black block column. The processing device 112 may further determine whether the width of the at least one black block row or the at least one black block column is greater than or equal to a preset width threshold.

If there is a black block row or black block column, and the width of the black block row or black block column is greater than or equal to the preset width threshold, the processing device 112 may proceed to perform operation 10805. Otherwise, the current masking state of the camera may be determined to be the normal operation state, and the processing device 112 may proceed to perform operation 10809.

In 10805, the processing device 112 (e.g., the image adjustment module 4902) may determine whether the at least one black block row or the at least one black block column is all rows or all columns of the captured frame.

If the at least one black block row or the at least one black block column is all rows or all columns of the captured frame, the processing device 112 may proceed to perform operation 10806. Otherwise, the current masking state of the camera may be determined to be the partial masking state, and the processing device 112 may proceed to perform operation 10810.

In 10806, the processing device 112 (e.g., the image adjustment module 4902) may determine whether the current shutter value and gain value of the camera reach the preset maximum values.

In response to a determination that the current shutter value and gain value of the camera reach the preset maximum values, the processing device 112 may proceed to perform operation 10807. Otherwise, the processing device 112 may return to perform operation 10801 (not shown).

In 10807, the processing device 112 (e.g., the image adjustment module 4902) may determine whether the duration of the camera being in the full-masking state reaches a preset duration threshold.

In response to a determination that the duration of the camera being in the full-masking state reaches the preset duration threshold, the processing device 112 may determine that the current masking state of the camera is the full-masking state, and proceed to perform operation 10808. Otherwise, the processing device 112 may return to perform operation 10801 (not shown).

In 10808, the processing device 112 (e.g., the image adjustment module 4902) may adjust the shooting parameters of the camera until the luminance values and chroma values of all image blocks in the captured frame are respectively less than or equal to the preset target luminance value threshold and the preset target chroma value threshold.

In 10809, in response to a determination that the state changes from the full-masking state or the partial masking state to the normal operation state, the processing device 112 (e.g., the image adjustment module 4902) may cancel the adjustment of the shooting parameters of the camera and the adjustment of the captured frame.

In 10810, the processing device 112 (e.g., the image adjustment module 4902) may adjust the captured frame based on a weighted luminance average value and chroma sum value corresponding to the captured frame. The processing device 112 may further control the camera to refocus based on the location information of non-black blocks in the captured frame.

According to some embodiments of the present disclosure, the image adjustment method provided in the present disclosure can automatically determine the current masking state of the camera, and adjust the camera's shooting parameters based on the current masking state of the camera and the camera adjustment strategy preset for the state to adjust the captured frame. For example, when the current masking state of the camera is the normal operation state, the adjustment of the shooting parameters is not restricted, that is, the shooting parameters are adjusted spontaneously through the ISP module in the related technology to adjust the captured frame. When the current masking state of the camera is the partial masking state, the first weight coefficient and the second weight coefficient can be set respectively for the black blocks and non-black blocks in the captured frame, so that the ISP module can adjust the shooting parameters based on the weighted luminance average value of the captured frame and the chroma sum value of non-black blocks to reduce problems such as noise, color cast, etc., in the non-blocked regions of the captured frame as much as possible to improve the quality of the captured frame. When the current masking state of the camera is the full-masking state, the shooting parameters can be adjusted through the ISP module until the luminance value and chroma value of any image block in the captured frame meet the preset target luminance value threshold and target chroma value threshold, making the captured frame similar to the state (i.e., a picture) when the camera is turned off, thereby improving the user experience.

More descriptions regarding the determination of the black blocks and the state of the camera and the adjustment of the shooting parameter of the camera may be found elsewhere in the present disclosure, e.g., FIG. 5A and the descriptions thereof.

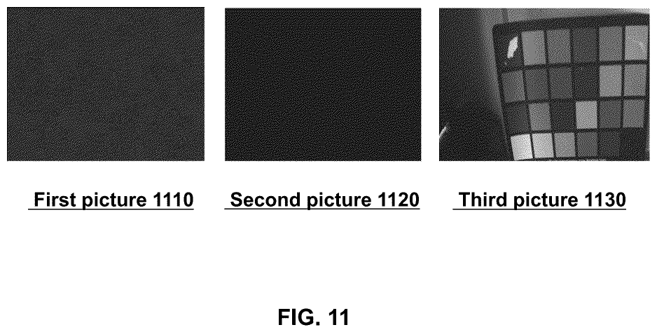

FIG. 11 is a schematic diagram illustrating exemplary captured frames adjusted before and after by the image adjustment method provided in some embodiments of the present disclosure. As shown in FIG. 11, from left to right, the first picture 1110 is a captured frame obtained without using the image adjustment method provided in the present disclosure when the camera is in the full-masking state. The second picture 1120 is a captured frame obtained using the image adjustment method provided in the present disclosure when the camera is in the full-masking state. The third picture 1130 is a captured frame obtained using the image adjustment method provided in the present disclosure when the camera is in the normal operation state.

The operations of the illustrated processes 500A, 500B, 700, 900, and 1000 presented above are intended to be illustrative. In some embodiments, a process may be accomplished with one or more additional operations not described, and/or without one or more of the operations discussed. Additionally, the order in which the operations of a process described above is not intended to be limiting.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer-readable media having computer readable program code embodied thereon.

Anon-transitory computer readable signal medium may include a propagated data signal with computer readable program code embodied therein, for example, in baseband or as part of a carrier wave. Such a propagated signal may take any of a variety of forms, including electromagnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object-oriented programming language such as Java, Scala, Smalltalk, Eiffel, JADE, Emerald, C++, C#, VB. NET, Python or the like, conventional procedural programming languages, such as the “C” programming language, Visual Basic, Fortran, Perl, COBOL, PUP, ABAP, dynamic programming languages such as Python, Ruby, and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution, e.g., an installation on an existing server or mobile device.

Similarly, it should be appreciated that in the foregoing description of embodiments of the present disclosure, various features are sometimes grouped together in a single embodiment, figure, or description thereof to streamline the disclosure aiding in the understanding of one or more of the various inventive embodiments. This method of disclosure, however, is not to be interpreted as reflecting an intention that the claimed object matter requires more features than are expressly recited in each claim. Rather, inventive embodiments lie in less than all features of a single foregoing disclosed embodiment.

In some embodiments, the numbers expressing quantities, properties, and so forth, used to describe and claim certain embodiments of the application are to be understood as being modified in some instances by the term “about,” “approximate,” or “substantially.” For example, “about,” “approximate” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

What is claimed is:

1. A method for image adjustment, comprising:
determining information of a black block based on pixel parameters of image blocks in a captured frame of a camera, the image blocks being determined based on pre-dividing the captured frame;
determining a target state of the camera from preset states of the camera based on the information of the black block, the preset states including a normal operation state, a partial masking state, and a full-masking state, wherein the determining the target state of the camera includes:
in response to an area of the black block and an area of the captured frame satisfying a first area condition, and a current shutter parameter and a current gain parameter of the camera satisfying a preset parameter condition, determining the target state to be the full-masking state; and
adjusting a shooting parameter of the camera based on the target state of the camera.

2. The method of claim 1, wherein
the information of the black block comprises at least one of a location, an area, or a distribution region of the black block,
the first area condition is that the area of the black block is the same as the area of the captured frame, and
the preset parameter condition is that the current shutter parameter and the current gain parameter of the camera reach correspondingly preset maximum values, respectively.

3. The method of claim 1, wherein the determining the target state to be the full-masking state includes:
in response to the area of the black block and the area of the captured frame satisfying the first area condition, and the current shutter parameter and the current gain parameter of the camera satisfying the preset parameter condition, determining the target state to be an initial full-masking state; and
in response to a duration of the initial full-masking state being greater than or equal to a preset time, determining the target state to be the full-masking state.

4. The method of claim 1, wherein the determining the target state of the camera further includes:
determining the target state to be the partial masking state in response to the area of the black block and the area of the captured frame satisfying a second area condition, the second area condition being that the area of the black block is less than the area of the captured frame and greater than or equal to a preset area threshold.

5. The method of claim 4, wherein the determining the target state to be the partial masking state in response to the area of the black block and the area of the captured frame satisfying a second area condition includes:
in response to the area of the black block and the area of the captured frame satisfying the second area condition,
determining whether a distribution region of the black block includes at least one black block row or at least one black block column; and
in response to the distribution region of the black block comprising the at least one black block row or at least one black block column, determining the target state to be the partial masking state.

6. The method of claim 4, wherein the determining the target state to be the partial masking state in response to the area of the black block and the area of the captured frame satisfying a second area condition includes:
in response to the area of the black block and the area of the captured frame satisfying the second area condition,
determining whether a distribution region of the black block includes at least one black block row or at least one black block column; and
in response to the distribution region of the black block comprising the at least one black block row or at least one black block column, and a short side of the at least one black block row or at least one black block column being greater than or equal to a preset width, determining the target state to be the partial masking state; wherein
a long side of the at least one black block row or at least one black block column coincides with and is equal in length to a side of the captured frame.

7. The method of claim 1, wherein the determining the target state of the camera further includes:
determining the target state to be the normal operation state in response to the area of the black block satisfying a third area condition, the third area condition being that the area of the black block is less than a preset area threshold.

8. The method of claim 7, wherein the determining the target state to be the normal operation state in response to the area of the black block satisfying a third area condition includes:
in response to the area of the black block satisfying the third area condition and a distribution region of the black block satisfying a preset distribution condition, determining the target state to be the normal operation state,
wherein the preset distribution condition includes one of the following:
no black block row or black block column exists in the distribution region of the black block; or
the distribution region of the black block includes the black block row or the black block column, and a short side of any one of the black block row or the black block column is smaller than a preset width.

9. The method of claim 1, wherein the adjusting a shooting parameter of the camera based on the target state includes:
in response to the target state being the full-masking state, determining whether the pixel parameters of the image blocks are greater than a preset value, wherein the pixel parameters include a luminance parameter and a chroma parameter; and
in response to the pixel parameters being greater than the preset value, adjusting the shooting parameter until the pixel parameter are less than or equal to the preset value.

10. The method of claim 1, wherein the adjusting a shooting parameter of the camera based on the target state includes:
in response to the target state being the partial masking state,
determining a first luminance average of the captured frame based on a luminance parameter of the black block and a luminance parameter of non-black block of the captured frame;
determining a first chroma sum value based on a chroma parameter of the non-black block; and
adjusting the shooting parameter of the camera based on the first luminance average and the first chroma sum value.

11. The method of claim 10, wherein the adjusting the shooting parameter of the camera based on the first luminance average and the first chroma sum value includes:
determining a second luminance average and a second chroma sum value for a non-boundary region of the captured frame; and
adjusting the shooting parameter of the camera based on the first luminance average, the first chroma sum value, the second luminance average, and the second chroma sum value.

12. The method of claim 10, wherein the determining a first luminance average of the captured frame based on a luminance parameter of the black block and a luminance parameter of non-black block of the captured frame includes:
determining the first luminance average based on the luminance parameter of the black block, the luminance parameter of non-black block, a first weight coefficient corresponding to the black block and a second weight coefficient corresponding to the non-black block, the second weight coefficient being larger than the first weight coefficient.

13. The method of claim 12, wherein the first weight coefficient and the second weight coefficient correlate to a distribution characteristic of the black block and an environmental characteristic of the captured frame.

14. The method of claim 12, wherein the determining the first luminance average based on the luminance parameter of the black block, the luminance parameter of non-black block, a first weight coefficient corresponding to the black block and a second weight coefficient corresponding to the non-black block, the second weight coefficient being larger than the first weight coefficient includes:
determining a luminance average value of the black block based on the luminance parameter of the black block;
determining a luminance average value of the non-black block based on the luminance parameter of the non-black block, wherein the luminance average value of non-black block is determined based on a weighted summation, and the weighted summation is determined based on the luminance parameters of a plurality of sub-regions of a non-blocked region, and the plurality of sub-regions are determined based on grouping image blocks of the non-blocked region; and
determining the first luminance average based on the luminance average value of the black block, the luminance average value of non-black block, the first weight coefficient, and the second weight coefficient.

15. The method of claim 10, further includes:
in response to the target state being the partial masking state,
determining a location information of the non-black block in the captured frame; and
controlling the camera to refocus based on the location information of the non-black block.

16. The method of claim 15, wherein the controlling the camera to refocus based on the location information of the non-black block includes:
determining a non-boundary region or a region of interest in a non-blocked region based on the location information of the non-black block; and
controlling the camera to refocus based on the non-boundary region or the region of interest.

17. The method of claim 1, wherein the adjusting a shooting parameter of the camera based on the target state includes:
determining a target shooting parameter based on the pixel parameters of the image blocks, target pixel parameters of the image blocks, and a current shooting parameter of the camera.

18. The method of claim 1, wherein the adjusting a shooting parameter of the camera based on the target state includes:
in response to the target state being the normal operation state, and before the normal operation state, the target state being the full-masking state or the partial masking state,
restoring the shooting parameter to a default value.

19. A device for image adjustment, comprising:
at least one storage device storing executable instructions for image adjustment; and
at least one processor in communication with the at least one storage device, wherein when executing the executable instructions, the at least one processor is configured to cause the device to perform operations including:
determining information of a black block based on pixel parameters of image blocks in a captured frame of a camera, the image blocks being determined based on pre-dividing the captured frame;
determining a target state of the camera from preset states of the camera based on the information of the black block, the preset states including a normal operation state, a partial masking state, and a full-masking state, wherein the determining the target state of the camera includes:
in response to an area of the black block and an area of the captured frame satisfying a first area condition, and a current shutter parameter and a current gain parameter of the camera satisfying a preset parameter condition, determining the target state to be the full-masking state; and
adjusting a shooting parameter of the camera based on the target state of the camera.

20. A non-transitory computer readable medium, comprising a set of instructions, wherein when executed by a computer, the set of instructions direct the computer to perform a method, the method comprising:
determining information of a black block based on pixel parameters of image blocks in a captured frame of a camera, the image blocks being determined based on pre-dividing the captured frame;
determining a target state of the camera from preset states of the camera based on the information of the black block, the preset states including a normal operation state, a partial masking state, and a full-masking state, wherein the determining the target state of the camera includes:
in response to an area of the black block and an area of the captured frame satisfying a first area condition, and a current shutter parameter and a current gain parameter of the camera satisfying a preset parameter condition, determining the target state to be the full-masking state; and
adjusting a shooting parameter of the camera based on the target state of the camera.
